(19) United States
(12) Patent Application Publication
(10) Pub. No.: US 2015/0053650 A1
(43) Pub. Date: Feb. 26, 2015

(54) WIRE DISCHARGE MACHINING APPARATUS AND MANUFACTURING METHOD FOR SEMICONDUCTOR WAFERS USING THE SAME

(71) Applicants: Hidetaka Miyake, Tokyo (JP); Atsushi Itokazu, Tokyo (JP); Yosuke Nakanishi, Tokyo (JP)

(72) Inventors: Hidetaka Miyake, Tokyo (JP); Atsushi Itokazu, Tokyo (JP); Yosuke Nakanishi, Tokyo (JP)

(73) Assignee: Mitsubishi Electric Corporation, Chiyoda-ku, Tokyo (JP)

(21) Appl. No.: 14/390,189

(22) PCT Filed: Oct. 19, 2012
(86) PCT No.: PCT/JP2012/077154

§ 371 Date: Oct. 2, 2014

(30) Foreign Application Priority Data
Apr. 12, 2012 (JP) 2012-091172
Apr. 19, 2012 (JP) 2012-095430

(51) Int. Cl. B23H 7/10; B23H 9/00; B23H 1/02

(52) U.S. Cl. CPC B23H 7/10; B23H 1/028; B23H 9/00
USPC 219/69.12

(57) ABSTRACT

A wire discharge machining apparatus including a plurality of main guide rollers disposed in parallel at intervals, one wire that is wound between the guide rollers while being spaced apart from one another at a fixed pitch to form cutting wire sections between a pair of guide rollers and travels according to the rotation of the main guide rollers, and power feed terminal units that feed electric power to wires of the cutting wire sections. The wire discharge machining apparatus performs cutting of a work piece with the cutting wire sections, suspends cut-out of semiconductor wafers from the work piece in a state in which a part of the semiconductor wafers is connected to the work piece, brings the wires of the cutting wire sections close to one cut surfaces, and scans the cut surfaces in a discharge-machined state.

### FIELD

The present invention relates to a wire discharge machining apparatus and a manufacturing method for semiconductor wafers using the same and, more particularly, to a wire discharge machining apparatus that can manufacture, with high productivity, semiconductor wafers having high flatness of semiconductor wafer surfaces and a manufacturing method for semiconductor wafers using the same.

### BACKGROUND

As a cutting method for cutting out a semiconductor wafer having a thin plate shape from a semiconductor ingot, a wire saw system has been widely used. The wire saw system is a system for pressing a wire, on the surface of which fine abrasive grains having high hardness such as diamond are deposited, against the surface of the semiconductor ingot and cutting out semiconductor wafers from the semiconductor ingot with abrasion action of the abrasive grains.

A manufacturing method for semiconductor wafers by the wire saw system requires a long time for cutting and needs grinding and polishing processes for eliminating unevenness and flaws on a cut surface after the cutting. Therefore, production efficiency is low.

Concerning this problem, there has been proposed a cutting method for cutting semiconductor wafers from a semiconductor ingot with a discharge machining method and scanning semiconductor wafer surfaces one by one with a discharge wire after the cutting to thereby remove damaged layers and perform planarization of the surfaces (e.g., Patent Literature 1).

With the method described in Patent Literature 1, in the conventional wire discharge machining apparatus employing the cutting method for scanning semiconductor wafer surfaces one by one with a discharge wire after cutting to remove damaged layers and perform planarization of the surfaces, a long time is required for treatment and great improvement of productivity cannot be expected. Therefore, there is a problem in that it is difficult to manufacture, with high productivity, semiconductor wafers having satisfactory characteristics.

There has been proposed an apparatus that simultaneously cuts wafers having a thin plate shape from a columnar work piece with a plurality of cutting wire sections arranged in parallel. As a system for this apparatus, there are a wire saw system and a wire discharge machining system. As one kind of the wire saw system, there is a system for interposing a polishing material between the cutting wire sections and the work piece and pressing the polishing material against the surface of the work piece. Alternatively, there is also another wire saw system for machining wafers from a work piece with abrasion action caused by pressing a wire, on the surface of which fine abrasive grains having high hardness such as diamond are deposited, against the surface of the work piece. On the other hand, the wire discharge machining system is a system for supplying machining power to cutting wire sections, causing electric discharge between the cutting wire sections and a work piece, and melting and removing the work piece with thermal energy of the electric discharge (e.g., Patent Literature 2).

Further, to improve productivity, both of wafer machining apparatuses by the two kinds of machining systems make it possible to form a cutting wire section, in which a plurality of wires are arranged in parallel at a fixed pitch, by repeatedly winding one wire between a plurality of guide rollers and perform cutting of a work piece in a plurality of places simultaneously in parallel.

The conventional machining system such as the wire saw system or the wire discharge machining system for simultaneously cutting a plurality of wafers (thin plates) from an ingot with the cutting wire section has an object of only cutting wafers from a columnar work piece. That is, in such a machining system, a warp of a wafer machine surface caused because of a machining mechanism of the system or occurrence of damaged layers formed in a wafer machined surface layer section is inevitable. Therefore, in a state in which only the cutting is performed, specifications for enabling the wafers to be input to a semiconductor process are not satisfied in wafer quality such as a plate thickness, surface roughness, and damage to a crystal structure. Therefore, the wafers formed by a Czochralski method to obtain a desired physical property value and cut out from the ingot, which is a semiconductor material, undergo post processes such as grinding and polishing to satisfy satisfactory machined surface quality for enabling the wafers to be input to the semiconductor process. According to the post processes, the wafers after the cutting by the system explained above are finished to a predetermined plate thickness and surface roughness as wafers that can be input to the semiconductor process.

Even if finishing for obtaining high-quality wafers with a wafer cutting apparatus by the two machining systems is to be performed, a large external force acts on the wafers being simultaneously cut from the ingot, which is the work piece. In the wire saw system, machining reaction due to the abrasion action acts on the wafers. On the other hand, in the wire discharge machining system, vaporization explosive power of working fluid due to electric discharge acts on the wafers. Therefore, in both the two machining systems, as the diameter of the cut-out wafers becomes larger, the wafers become more easily deformed by an external force and cracked.

As explained above, in the wafers cut and obtained from the ingot, which is the work piece, plate thickness variation is large even if productivity of the wafers in an ingot cutting stage is improved. Alternatively, a problem of large thickness of damaged layers on the wafer surfaces greatly affects the post processes. That is, the problem increases a load of wafer machining in the grinding and the polishing, which are the post processes. That is, when the processes until wafers of requested specifications are finally obtained are considered comprehensively, there is a problem in that wafer production efficiency is deteriorated depending on wafer cutting conditions by the cutting wire section.

For example, Patent Literature 2 proposes a method of preventing deformation of the wafers due to an external force during the cutting in a multi-wire discharge machining system. In Patent Literature 2, an elastic member is pressed against a machining start end of a large number of wafers, which are being simultaneously formed by the cutting wire section, from the machining start end side of the wafers. The elastic member deformed by the pressing enters machined grooves between the wafers to stuff up gaps between the wafers. The gaps between the adjacent wafers are filled to suppress wafer fluctuation.

However, when the wafers are cut from the ingot by this system, if the elastic member is excessively pressed against wafer ends, the wafers are likely to be rather deformed on the contrary. Alternatively, if a pressing amount on the elastic member is insufficient, spaces remain in the gaps of the adjacent wafers and the wafers cannot be surely fixed to one another. In this way, adjustment of the pressing amount is difficult. Further, in a machining method for finishing wafers by repeatedly scanning, while performing discharge machining, a cutting wire section on machined surfaces of wafers being cut from an ingot, when stuffed wafer ends are subjected to discharge machining, there is a problem in which finishing cannot be performed because the cutting wire section interferes with the stuffing.

### CITATION LIST

### Patent Literature

Patent Literature 1: Japanese Patent Application Laid-Open No. 2007-30155
Patent Literature 2: Japanese Patent Application Laid-Open No. 2011-183477

### SUMMARY

### Technical Problem

As explained above, in the conventional wire discharge machining apparatus employing the cutting method for scanning semiconductor wafer surfaces one by one with a discharge wire after cutting to remove damaged layers and perform planarization of the surfaces, a long time is required for treatment and great improvement of productivity cannot be expected. In the multi-wire discharge machining system, when a plurality of wafers are simultaneously cut, it is difficult to support machining while surely maintaining a positional relation between the wafers. Therefore, it is difficult to manufacture, with high productivity, semiconductor wafers having satisfactory characteristics.

The present invention has been devised to solve such problems and it is an object of the present invention to obtain a wire discharge machining apparatus that can efficiently perform removal of damaged layers on semiconductor wafer surfaces and planarization of the semiconductor wafer surfaces and has high productivity of cutting out semiconductor wafers from a semiconductor ingot and high machining accuracy, and a manufacturing method for semiconductor wafers using the apparatus.

It is another object of the present invention to obtain a wire discharge machining apparatus that can perform cutting and finishing with collective treatment in the same apparatus.

It is still another object of the present invention to obtain a wire discharge machining apparatus that not only enables cutting of an ingot but also enables a plurality of wafers formed by cutting the ingot in a thin plate shape to be finished to have a plate thickness and surface roughness close to final required specifications.

### Solution to Problem

In order to solve the aforementioned problems, a wire discharge machining apparatus according to one aspect of the present invention is configured to include: a pair of guide rollers disposed in parallel at intervals; a wire that is wound between the pair of guide rollers a plurality of times while being spaced apart from each other at a fixed pitch to form a parallel wire section between the pair of guide rollers and travels according to the rotation of the guide rollers; a pair of damping guide rollers that are provided between the pair of guide rollers, follow and come into contact with the parallel wire sections, and form a plurality of damped cutting wire sections; a plurality of power feed terminals that feed electric power to each of the cutting wire sections; and a unit that moves a work piece to the cutting wire sections relatively in a parallel direction of wires forming the cutting wire sections and a direction perpendicular to the parallel direction of the wires forming the cutting wire sections in such a manner as to bring the wires of the cutting wire sections closer to either one of a pair of cut surfaces formed by being cut by the wires of the cutting wire sections than the other, wherein the wire discharge machining apparatus scans either one of the cut surfaces in a discharge-machined state to thereby simultaneously finish the cut surfaces.

### Advantageous Effects of Invention

The wire discharge machining apparatus of the present invention relatively moves in the direction perpendicular to the parallel arrangement direction of the wires forming the cutting wire sections while keeping the semiconductor wafers being cut attached in the apparatus and scans and planarizes the cut surfaces directly using the wires used for the cutting. Therefore, adjustment of the positions of the semiconductor wafers is unnecessary during the planarization machining, and accordingly it is made possible to reduce a manufacturing process and obtain the semiconductor wafer having satisfactory characteristics with high productivity.

### BRIEF DESCRIPTION OF DRAWINGS

FIG. 1 is a side view of the configuration of a wire discharge machining apparatus in a first embodiment.

FIG. 2 is a perspective view of the configuration of the wire discharge machining apparatus in the first embodiment.

FIG. 3 is an external view of a wire position where semiconductor ingot cutting is suspended in the first embodiment.

FIG. 4 is an explanatory diagram of tracks of wires of cutting wire sections in cutting and planarization of semiconductor wafers by a wire discharge machining system.

FIG. 5 is an explanatory diagram of tracks of the wires moved to cut off the semiconductor wafers from a semiconductor ingot in the first embodiment.

FIG. 6 is an external view of a fluctuation state of semiconductor wafer gaps due to vibration of the semiconductor wafers.

FIG. 7 is a conceptual diagram of a vibration prevention system for semiconductor wafers in a second embodiment.

FIG. 8 is an external view of the structure and the operation of wafer supporting sections in the second embodiment.

FIG. 9 is a side view of the configuration of a wire discharge machining apparatus in a third embodiment.

FIG. 10 is a perspective view of the configuration of the wire discharge machining apparatus in the third embodiment.

FIG. 11-1 is an external view and a sectional view of the structure of cutting-time wafer supporting sections and finishing-time wafer supporting sections in the third embodiment.

FIG. 11-2 is an external view and a front view of the structure of the cutting-time wafer supporting sections and the finishing-time wafer supporting sections in the third embodiment.

FIG. 12-1 is an explanatory diagram of the operation of wafer supporting sections in the third embodiment.

FIG. 12-2 is an explanatory diagram of the operation of the wafer supporting sections in the third embodiment.

FIG. 12-3 is an explanatory diagram of the operation of the wafer supporting sections in the third embodiment.

FIG. 12-4 is an explanatory diagram of the operation of the wafer supporting sections in the third embodiment.

FIG. 12-5 is an explanatory diagram of the operation of the wafer supporting sections in the third embodiment.

FIG. 12-6 is an explanatory diagram of the operation of the wafer supporting sections in the third embodiment.

FIG. 12-7 is an explanatory diagram of the operation of the wafer supporting sections in the third embodiment.

FIGS. 13(a) to 13(e) are explanatory diagrams of relative tracks of cutting wire sections with respect to a work piece in cutting and finishing of wafers by a wire discharge machining system.

FIGS. 14(a) and 14(b) are external views of the positions and the operations of wafer supporting sections 12 and a work piece 5 during segmentation in a fourth embodiment, where (a) is a top view and (b) is a front view.

FIG. 15 is an explanatory diagram of tracks of wires in planarization after cutting of semiconductor wafers by a wire discharge machining system and in cutting off the semiconductor wafers from a semiconductor ingot.

### DESCRIPTION OF EMBODIMENTS

### First Embodiment

### <Configuration of a Wire Discharge Machining Apparatus>

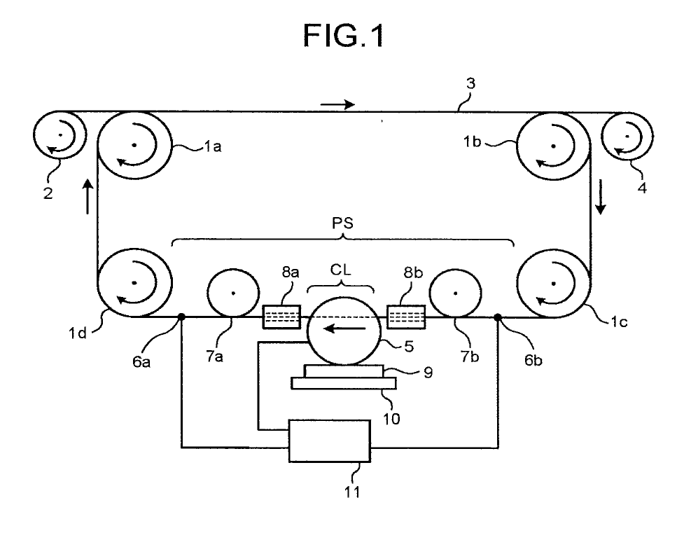

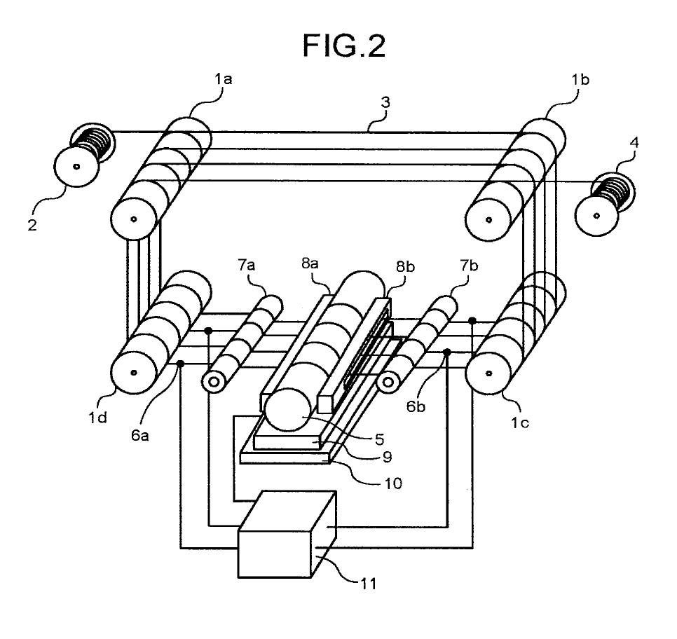

The configuration of a wire discharge machining apparatus according to a first embodiment of the present invention is explained with reference to FIG. 1 and FIG. 2. FIG. 1 is a side view of the configuration of the wire discharge machining apparatus in the first embodiment. FIG. 2 is a perspective view of the configuration of the wire discharge machining apparatus in the first embodiment.

A wire traveling system is configured by four main guide rollers 1a to 1d. A wire 3 is let out from a wire delivering bobbin 2 and wound around the main guide rollers 1a to 1d a plurality of times in parallel while keeping a fixed interval. The wire 3 travels according to the rotation of the main guide rollers 1a to 1d, and finally wound by a wire winging bobbin 4. The main guide rollers 1c and 1d are set in positions interposing a work piece 5 therebetween. A plurality of wires 3 stretched at fixed tension and spaced apart in the axial direction of the main guide roller 1c are arranged between the main guide rollers 1c and 1d. In the first embodiment, for the wire 3, a wire made of steel having a diameter of 0.1 millimeter and coated with brass in 1 micrometer on the surface is used.

In the first embodiment, portions where the wires 3 are stretched and the wires 3 are spaced apart and arrayed between the main guide roller 1c and the main guide roller 1d are referred to as a parallel wire section PS. In the parallel wire section PS, portions opposed to the work piece 5 where the wires are linearly stretched and used for cutting of the work piece 5 are referred to as cutting wire sections CL. In the cutting wire sections CL, the wires 3 are arrayed in parallel at a fixed interval. A plurality of semiconductor wafers can be simultaneously cut out from the work piece 5.

Damping guide rollers 7a and 7b are arranged at both ends of the cutting wire sections CL. Power feed terminal units 6a and 6b that supply electric power to the wires 3 are attached to the outer side of the damping guide rollers 7a and 7b. Stable discharge machining can be performed in all the wires 3 by supplying electric power separately to the individual wires 3. On the other hand, terminals on a power feed side of a power supply unit 11 are respectively electrically connected to the power feed terminal units 6a and 6b. A terminal on a ground side is electrically connected to the work piece 5. Therefore, a voltage pulse output from the power supply unit 11 is applied between the wires 3 of the cutting wire sections CL and the work piece 5.

Between the two damping guide rollers 7a and 7b, nozzles 8a and 8b are arranged to be opposed to each other to hold the cutting wire sections CL therebetween. The nozzles 8a and 8b jet machining fluid to cut sections of the work piece 5 along the cutting wire sections CL. The cutting wire sections CL are arranged to pierce through the nozzles 8a and 8b. However, the inner surfaces of the nozzles 7a and 7b and the wires 3 are not in contact with each other. A wafer-parallel-direction moving stage 9 controls movement of the work piece 5 in a direction in which the wires 3 of the cutting wire sections CL are arranged in parallel, that is, a direction orthogonal to a cutting direction by the wires 3. A lifting and lowering stage 10 places the work piece 5 thereon and controls lifting and lowering of the work piece 5.

The main guide rollers 1a to 1d are rollers formed by winding a rubber material of urethane rubber or the like around columnar cored bars. The main guide rollers 1a to 1d are rotatable with both ends of the cored bars supported by bearings. A high coefficient of friction of the rubber on the surfaces of the main guide rollers 1a to 1d and the wires 3 is suitable for preventing the wires 3 from slipping and idling on the main guide rollers 1a to 1d. On the surfaces of the main guide rollers 1a to 1d, grooves are formed at an interval same as a wire winding pitch. The wires 3 pass through the respective grooves. Therefore, an interval of the wires 3 in the cutting wire sections CL can be kept fixed. The interval of the wires 3 in the cutting wire sections CL can be set according to a purpose. For the purpose of cutting semiconductor wafers as in this embodiment, about 0.1 to 0.8 millimeter is suitable. The main guide rollers 1a to 1d and the work piece 5 are immersed in the machining fluid. The cutting wire sections CL are opposed to the work piece 5 in the machining fluid. The wires 3 simultaneously perform cutting in parallel.

The damping guide rollers 7a and 7b are driven guide rollers having high shape accuracy, high rotation accuracy, and high attachment accuracy compared with the main guide rollers 1a to 1d. Two damping guide rollers are used in places across the cutting wire sections CL as explained above. The damping guide rollers 7a and 7b are arranged to be pressed against the wires 3 stretched between the main guide rollers 1c and 1d such that the wires 3 come into contact with parts of the outer circumferences of the damping guide rollers 7a and 7b. As a result, between the damping guide rollers 7a and 7b, the wires 3 are linearly stretched and vibration involved in the traveling of the wires 3 can be suppressed. That is, it is possible to suppress vibration of the wires 3 of the cutting wire sections CL and perform cutting of the work piece 5 at high accuracy.

The power feed terminal units 6a and 6b are aligned at an interval same as the winding pitch of the wires 3. Electric power is fed to the wires 3 of the cutting wire sections CL from the power feed terminal units 6a and 6b. Machining currents respectively flow to the wires 3. In this embodiment, regarding the contacts for supplying electric power from the power feed terminal units 6a and 6b to the wires 3, cross sections attached with groove-like wire guides are formed in a circular shape of an arcuate shape. To secure satisfactory contact for a long period, the contact portions with the wires 3 are periodically rotated and changed.

<Cutting by the Wire Discharge Machining Apparatus>

Cutting by the wire discharge machining apparatus in this embodiment is explained below. Wire discharge machining is machining for causing arc discharge in very small discharge gaps between the wires 3 and the work piece 5 immersed in the machining fluid such as deionized water and cutting the work piece 5. Specifically, the surface of the work piece 5 is heated to high temperature by the arc, and the machining fluid present in the discharge gaps explosively vaporizes to blow off a high-temperature portion of the work piece 5. The blown-off portion floats in the machining fluid as machining chips.

During the machining, the wire 3 is continuously let out from the wire delivering bobbin 2, travels according to the rotation of the main guide rollers 1a to 1d, and is collected in the wire winding bobbin 4. Tension during the traveling of the wires 3 arranged in parallel is controlled by adjusting rotating speed of the wire delivering bobbin 2 and that of the wire winding bobbin 4. When a traveling state of the wires 3 is stable, the tension of the traveling wires 3 is kept fixed.

When discharge machining is performed, while the main guide rollers 1c and 1d are rotated to cause the wire 3 to travel, after the work piece 5 is arranged to be opposed to the cutting wire sections CL a predetermined distance apart therefrom, a voltage pulse is applied to the cutting wire sections CL from the power supply unit 11. The lifting and lowering stage 10 is lifted according to cutting speed. In a state in which the discharge gaps are kept fixed, the arc discharge is continued while the cutting wire sections CL and the work piece 5 are relatively moved. Then, machined grooves are formed in portions where wire 3, which is wound to be parallel wires, of the cutting wire sections CL pass the work piece 5.

Regarding the power feed terminal units 6a and 6b, a mechanism (not shown) for moving the power feed terminal units 6a and 6b in a direction perpendicular to the wires 3 is provided to adjust a pressing amount against the wires 3. Contact resistance can be adjusted and a discharge current value per one voltage pulse can be finely adjusted by adjusting the pressing amount of the power feed terminal units 6a and 6b against the wires 3. Note that it goes without saying that a machining current value can be adjusted by adjusting an output voltage of the power supply unit 11 because electric power is fed to the cutting wire sections CL via the power feed terminal units 6a and 6b.

In this embodiment, conditions used in the cutting of the semiconductor ingot, which is the work piece 5 to be machined by the wire discharge machining, are an applied voltage of 100 volts, a machining current of 3 to 5 amperes, a pulse width of 0.1 microsecond, a duty ratio of 50%, and wire traveling speed of 0.1 mm/min. These cutting conditions are not particularly limited and can be variously adjusted and used according to a type and thickness of the wire 3 in use, the material of the work piece 5, and the like.

<Planarization of a Cut Surface by the Wire Discharge Machining Apparatus>

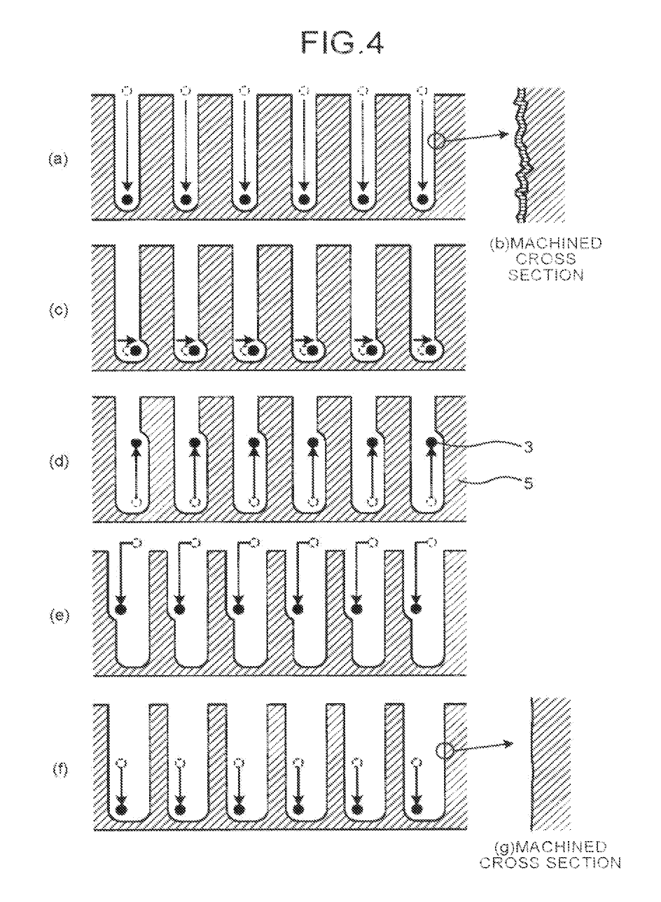

The work piece 5 is cut by the wire discharge machining apparatus, a cutting process is suspended before the semiconductor wafer is completely cut, and planarization of cut surfaces is performed. A planarization method for the cut surfaces in the first embodiment is explained with reference to FIGS. 3 and 4.

FIG. 3 is an external view of a wire position where semiconductor ingot cutting is suspended in the first embodiment. FIG. 4 is an explanatory diagram of tracks of the wires 3 of the cutting wire sections CL in cutting and planarization of a semiconductor wafer by the wire discharge machining system. A cross section of the work piece 5 in a cut portion is shown. Black circles indicate the cross sections of the wires 3.

A pulse voltage is applied to each of the wires 3 of the cutting wire sections CL to cut the work piece 5 to the halfway. A cutting process is suspended in a position where several millimeters are left to completely cut the work piece 5 (FIG. 3 and FIG. 4(a)). In this embodiment, the suspended position is a position where several millimeters are left to completely cut the work piece 5. As shown in FIG. 3, semiconductor wafers are connected to the semiconductor ingot with several millimeters left in a lower portion of the semiconductor ingot. However, the remaining portion is not limited to this. A portion connected to the semiconductor ingot, which is the work piece 5, only has to be left. In a state in which the work piece 5 is left as cut by the discharge machining, as schematically shown in FIG. 4(b), damaged layers are formed and unevenness is large on cut surfaces of the work piece 5. Note that, in the explanation of the planarization, in FIG. 4, the wires 3 are shown as if the wires 3 are moving. However, actually, the semiconductor ingot, which is the work piece 5, is moving. The wires 3 relatively move in cut portions of the work piece 5.

While a pulse voltage is applied to the wires 3 of the cutting wire sections CL, the wires 3 are brought close in one cut surface direction by about several micrometers to 10 micrometers (FIG. 4(c)). Thereafter, the wires 3 are scanned in the upward direction in a discharge state (FIG. 4(d)). A discharge machining condition at this point is set slightly weaker than a discharge machining condition in the cutting process. Specifically, in this embodiment, the pulse voltage is set to 50 volts, which is a half of the pulse voltage in the cutting process. By repeating this (FIG. 4(e)), the deformed layer of the cut surfaces can be removed and the cross section thereof can be planarized (FIG. 4(f) and FIG. 4(g)). In this embodiment, the wires 3 are each brought close to the cut surface on one side and scanned to remove the damaged layer. However, the wires 3 can be scanned each in the center portion of the both cut surfaces without being brought close to the cut surface on one side. However, in this case, to apply the discharge machining to the damaged layer of the cut surface formed by the ingot cutting, the scanning speed of the wires 3 is reduced to increase a discharge occurrence probability, or the pulse voltage is increased to a degree in which electric discharge occurs even at an inter-electrode distance to the damaged layer to be removed. In this way, regarding the distance between the cut surface and the wire 3, an optimum distance can be selected on the basis of the discharge machining condition and the speed of the scanning.

Regarding the planarization of the cut surface by the discharge machining of each of the wires 3, in a part of the cut surface where unevenness is large because of the damaged layer, electric discharge is caused in a process of scanning the wire 3 to gradually reduce the unevenness. When the center portion of both the cut surfaces are scanned, it is preferable that electric discharge occurs between the wire 3 and both the cut surfaces. When the wire 3 is brought close to the cut surface on one side (hereinafter may be referred to just as “one-side cut surface”) and scanned, it is preferable that electric discharge occurs between the wire 3 and the cut surface close to the wires 3. The number of the wires 3 of the cutting wire sections CL is not particularly limited. Even in a structure in which a plurality of the wires 3 are arrayed in parallel, the cutting wire sections CL can be configured by only one wire 3. However, the number of the wires 3 relates to the number of substrates that can be simultaneously processed. From the viewpoint of improving productivity, it is preferable that the cutting wire sections CL are configured by a plurality of the wires 3.

By performing the scanning with the wires 3 many times while causing electric discharge, the unevenness of the damaged layers formed during the cutting is removed little by little and flat cut surfaces can be obtained. Because the cutting process is stopped and the cut surfaces are scanned and planarized directly using the wires used for the cutting while the semiconductor wafer being cut is kept attached in the apparatus, adjustment of positions such as alignment of orientations of machined surfaces of semiconductor wafers is made unnecessary during the planarization, so that it is made possible to reduce a manufacturing process and obtain semiconductor wafers having satisfactory characteristics with high productivity.

<Cutting (Cut-Off) by the Wire Discharge Machining Apparatus>

After the planarization process for the cut surfaces ends, the portion connected to the semiconductor ingot, which is the work piece 5, is cut off using a discharge machining method. First, the wires 3 are returned to positions where the cutting process is suspended. After a discharge machining condition is set to the same condition as that during the cutting of the wires 3, the work piece 5 is moved in a direction perpendicular to the paper surface of FIG. 3, and the semiconductor ingot and the semiconductor wafers are simultaneously cut. Cutouts (orifla: orientation flats) for discriminating the front and the back of the semiconductor wafers are necessary regarding in the semiconductor wafers. However, in the present invention, regarding the semiconductor ingots to be machined into wafers, if a semiconductor ingot subjected to outer circumference polishing or the like taking into account crystal orientation such that orientation flat portions are present on the bottom surface of the semiconductor ingot is used, labor and time for checking positions and forming the orientation flats are unnecessary. Therefore, it is possible to improve machining efficiency.

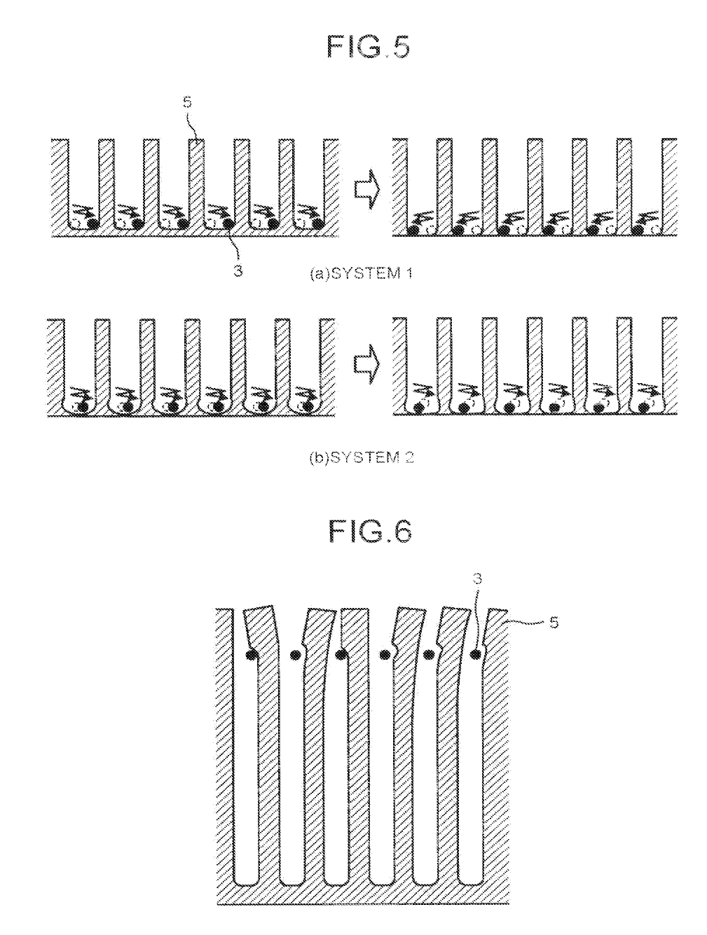

An example of a cutting-off method after the planarization of the cut surfaces is shown in FIG. 5. FIG. 5 is an explanatory diagram of tracks of the wires moved to cut off the semiconductor wafers from the semiconductor ingot in the first embodiment. The cross section of the semiconductor ingot, which is the work piece 5, is shown. Black circles indicate the cross sections of the wires 3. Two kinds of methods, i.e., a system 1 (FIG. 5(a)) and a system 2 (FIG. 5(b)) are explained. However, the cutting-off method is not limited to these methods.

After the process of planarization by the discharge machining ends, the wires 3 of the cutting wire sections CL are returned to the positions where the cutting is suspended. In the system 1, as shown in FIG. 5(a), while the wires 3 are reciprocatingly moved by a large distance in cut grooves (gaps of the semiconductor wafers), the discharge machining is performed to cut the portion connected to the semiconductor ingot, which is the work piece 5. In the system 2, as shown in FIG. 5(b), the wires 3 are reciprocatingly moved by a small distance in the cut grooves and discharge machining energy larger than that during the cutting to cut the portion in a short time.

As explained above, the method in this embodiment includes a first step of cutting semiconductor wafers from an ingot to leave a connecting portion and forming cut cross sections, a second step of relatively moving wires in a direction approaching the cut cross section formed in the first step and performing finishing, and a third step of arranging the wires in positions where the cut-out of the semiconductor wafers is suspended, reciprocatingly moving the wires in a thickness direction of gaps cut by the wires while performing discharge machining, and simultaneously advancing a suspended cutting-out process.

In FIG. 6, an external view of a fluctuation state of semiconductor wafer gaps due to vibration of the semiconductor wafers is shown. When the diameter of a semiconductor ingot to be cut is large, that is, as semiconductor wafers to be machined is increased in diameter, as shown in FIG. 6, the semiconductor wafers still connected to the semiconductor ingot greatly vibrate. Whereas the plate thickness of the semiconductor wafers is about several hundred micrometers irrespective of the diameter of the semiconductor wafers, the height of the semiconductor wafers is large in a range of several centimeters to ten and several centimeters. When a ratio of the height of the semiconductor wafers to the plate thickness of the semiconductor wafers is large, the rigidity in the plate thickness direction of the semiconductor wafers decreases. The semiconductor wafers tends to vibrate with a flow of machining fluid supplied during the discharge machining.

During the cutting of the semiconductor ingot, the machining fluid is powerfully jetted to the machined grooves from machining fluid nozzles. However, during the planarization in the first embodiment, when the machining fluid is supplied to the machined grooves under conditions same as the conditions during the cutting, the semiconductor wafers before being cut off from the semiconductor ingot greatly vibrate. In the discharge machining, when discharge gaps between the cutting wire sections CL and the cut surfaces of the semiconductor ingot, which is the work piece 5, greatly fluctuate, the discharge machining becomes unstable and machining accuracy of cut surfaces of the semiconductor wafers is deteriorated.

Therefore, during the planarization, a supply flow rate or a fluid pressure of the machining fluid is reduced to prevent the semiconductor wafers from vibrating with the machining fluid flow. In the planarization, a machining chip amount is not so large as in the cutting because only about 10 micrometers from the surfaces of the semiconductor wafers is removed. Further, a machined groove width is increased. Because the machining chips are easily discharged from the machined grooves, it is unnecessary to powerfully supply the machining fluid into the machined grooves. Therefore, a machining fluid supply amount during the planarization is reduced to about ½ to 1/10 of a machining fluid supply amount during the cutting to perform the planarization.

By using the wire discharge machining apparatus and the manufacturing method for semiconductor wafers described in this embodiment, the cut surfaces are scanned by the wires 3 many times under the discharge machining condition weaker than that during the cutting, the unevenness of the damaged layers formed during the cutting is removed little by little, and flat cut surfaces can be obtained. While cutting process is suspended and the semiconductor wafers being cut is kept attached in the apparatus, the cut surfaces are scanned and the planarization of the cut surfaces are performed directly using the same wires used for the cutting. Therefore, adjustment of the positions of the semiconductor wafers is unnecessary during the planarization, and thus it is made possible to reduce the manufacturing process and obtain the semiconductor wafers having satisfactory characteristics with high productivity.

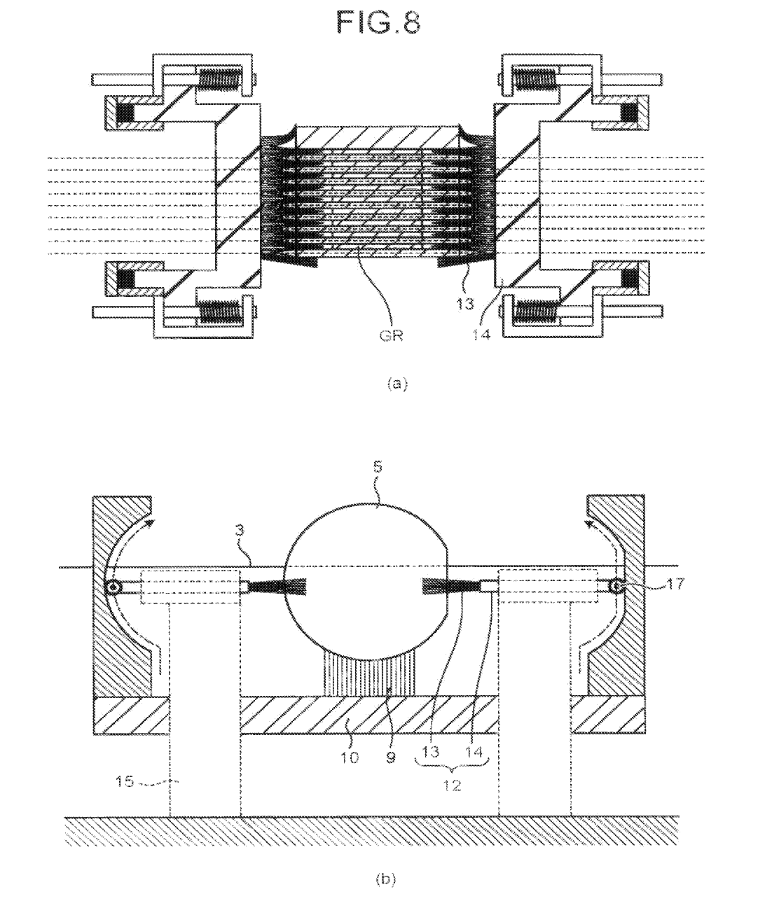

As shown in FIG. 8(b), a recess is formed in the wafer-parallel-direction moving stage 9 according to the external shape of the work piece 5. The work piece 5 is enabled to slide only in a direction in which expansion is caused by cutting. Therefore, the work piece 5 is cut while positional deviation is suppressed. After the cutting, the work piece 5 is finished while the position of the work piece 5 is maintained. That is, wafer supporting sections 12 (cutting wafer supporting sections and finishing wafer supporting sections) are used during both the cutting and during the finishing. The positions of the wafer supporting sections 12 are enabled to move only in the longitudinal direction of the ingot. The cutting and the finishing are performed according to the up-down movement of the supporting section. Therefore, it is possible to extremely efficiently carry out the cutting and the finishing for a large number of wafers at high accuracy.

### Second Embodiment

A configuration and an operation in a second embodiment of the present invention are explained. In a wire discharge machining apparatus according to this embodiment, vibration of semiconductor wafers and the like in processes of cutting of the semiconductor wafers by a discharge machining method and planarization of cut surfaces is suppressed. Fluctuation and the like of substrate thickness involved in the vibration is prevented. Concerning other cutting and the like by discharge machining, explanation is omitted because a configuration and an operation same as those in the first embodiment are used. The configuration and the operation of wafer supporting sections that suppress vibration of semiconductor wafers during machining different from those in the first embodiment are mainly explained.

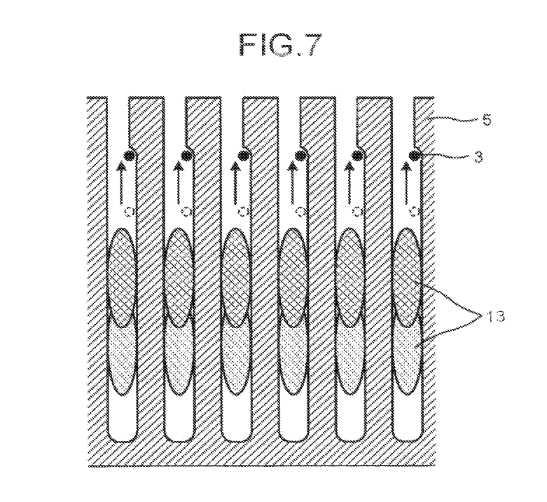

The wafer supporting sections 12 and a vibration suppressing method for semiconductor wafers in the second embodiment of the present invention are explained with reference to FIG. 7 and FIG. 8. FIG. 7 is a conceptual diagram of a vibration preventing system for semiconductor wafers in the second embodiment. FIG. 8 is an external view of the structure and the operation of the wafer supporting sections 12 in the second embodiment. FIG. 8(a) is a top view and FIG. 8(b) is a front view.

The wafer supporting sections 12 are configured by thin line bundle sections 13 formed by bundling thin lines having a diameter of several ten micrometers and length of about 30 millimeters and insertion supporting sections 14, which are handles for making it easy to insert the thin line bundle sections 13 into cut groove portions of a semiconductor ingot, which is the work piece 5. The wafer supporting sections 12 have a shape similar to a brush as a whole. The thin lines forming the thin line bundle sections 13 need to be a nonconductive material having high flexibility and strength enough for not being deformed by the own weight. As an example, a nonconductive material made of resin such as nylon or polyacrylate and machined in a piliform can be used.

In the wafer supporting sections 12, the thin line bundle sections 13 are portions to be inserted into machined groove GR portions between the semiconductor wafers. With the flexibility of the thin lines, the distal ends of the bound thin lines are inserted into the gaps between the semiconductor wafers having narrow spaces. The semiconductor wafers are stuffed in a wedge shape by the inserted thin line bundle sections 13. Regarding the insertion of the thin line bundle sections 13, the insertion supporting sections 14 are actuated to insert the thin line bundle sections 13 between the semiconductor wafers, that is, into the machined grooves in parallel to a wire stretching direction and from both side directions of the semiconductor wafers interposing the semiconductor ingot therebetween, which is the work piece 5. As a relative positional relation between the wires 3 of the cutting wire sections CL and the thin-line bundle sections 13, the thin line bundle sections 13 are disposed, with respect to the wires 3, on a side where the semiconductor wafers are connected. The thin line bundle sections 13 are inserted into machined grooves GR between the semiconductor wafers to stuff up the machined grooves GR to prevent vibration of the semiconductor wafers.

FIG. 7 denotes a sectional schematic views of the semiconductor ingot, which is the work piece 5, cut to the halfway. Black circles indicate the cross sections of the wires 3 of the cutting wire sections CL. Two kinds of ellipses respectively indicate the thin line bundle sections 13 of the wafer supporting sections 12 in the cutting grooves. The thin line bundle sections 13 work to reduce vibration of the semiconductor wafers partially connected to the semiconductor ingot. The thin line bundle sections 13 of the wafer supporting sections 12 are inserted into the cutting grooves to prevent vibration of the semiconductor wafers and perform planarization of cut surfaces on a semiconductor wafer cutting start side.

Fluctuation due to a swing of the entire semiconductor wafers is larger at the end on the semiconductor wafer machining start side. Therefore, when the wires 3 of the cutting wire sections CL planarize the vicinity of the end on the semiconductor wafer machining start side, discharge gaps most easily fluctuate. Therefore, when a scanning position of the cutting wire sections CL is present near the end on the semiconductor wafer machining start side, the wafer supporting sections 12 are inserted into the gaps between the semiconductor wafers in positions about 10 millimeters away from the wires 3 of the cutting wire sections CL on a side where the semiconductor wafers are connected by the semiconductor ingot. The semiconductor wafers are fixed by the wafer supporting sections 12 inserted into the gaps between the semiconductor wafers like wedges. Discharge gaps between the cutting wire sections and the semiconductor wafer machined surfaces are maintained fixed. Therefore, stable planarization discharge machining is performed.

FIG. 8 shows the configuration and the operation of the wafer supporting sections 12 used in this embodiment. The semiconductor ingot, which is the work piece 5, is set on the lifting and lowering stage 10. The wafer supporting sections 12 including the thin line bundle sections 13 and the insertion supporting sections 14 are fixed to wafer supporting section stands 15. In the cutting process for the work piece 5 and the planarization process for the cut surfaces, the wires 3 and the wafer supporting sections 12 do not move. That is, in the cutting and planarization processes for the work piece 5, the lifting and lowering stage 10 and the semiconductor ingot, which is the work piece 5, set on the lifting and lowering stage 10 move up and down. The wafer supporting sections 12 include the thin line bundle sections 13 functioning as inserting sections that are inserted into the machined grooves GR functioning as inter-wafer regions and retain wafer intervals, the insertion supporting sections 14 that support the thin line bundle sections 13, and rolling rollers 17 connected to the insertion supporting sections 14. The rolling rollers 17 roll along the surface shape of the insertion supporting sections 14, whereby an insertion amount of the thin line bundle sections 13 into the machined grooves GR formed in the work piece 5 is controlled. The wafer supporting sections 12 configure cutting-time wafer supporting sections and finishing-time wafer supporting sections both during the cutting and during the finishing. The wafer supporting sections 12 are configured to be capable of retaining a positional relation between the supporting sections.

First, the lifting and lowering stage 10 and the semiconductor ingot, which is the work piece 5, rise upward, and the work piece 5 is cut by the wires 3 according to the discharge machining method. In the process up to this point, the wafer supporting sections 12 are retracted (not shown in the figure) so as not to interfere with the wires 3 or the semiconductor ingot, which is the work piece 5. Thereafter, the cutting is suspended in a state in which a part of the semiconductor wafers is connected to the semiconductor ingot. The lifting and lowering stage 10 is lowered. Further, the wafer supporting sections 12 are returned to a predetermined position from the retracted position. To scan cut surfaces with the wires 3 and planarize the cut surfaces, the lifting and lowering stage 10 is moved up and down. In this case, the wafer supporting sections 12 move in the left-right direction according to the curvature of a jig around the wafer supporting sections 12, insert the thin line bundle sections 13 into gaps between the semiconductor wafers, and suppress vibration in planarizing the cross sections with the scanning of the wires 3. The thin lines inserted into the gaps between the semiconductor wafers do not always need to be a plurality of thin lines. The number of the thin lines inserted into the gap between the semiconductor wafers can be any number as long as the thin lines have an effect of suppressing vibration of the semiconductor wafers in a relation between the size of the gap and the thickness of the thin lines.

According to the processes explained above, when the process for cutting the semiconductor ingot, which is the work piece 5 is suspended, and the planarization is performed under the conditions weaker than the discharge machining condition during the cutting of the cut surfaces by the wires 3 of the cutting wire sections CL, the thin line bundle sections 13 of the wafer supporting sections 12 can be inserted into the gaps between the semiconductor wafers and suppress vibration of the semiconductor wafers. Therefore, it is possible to obtain satisfactory semiconductor wafers without fluctuation in substrate thickness due to vibration.

The direction for inserting and pulling out the wafer supporting sections 12 is set to be parallel to the directions of the wires of the cutting wire sections CL. This is for the purpose of preventing, when the semiconductor wafers are held from the semiconductor wafer cutting start side, the wafer supporting sections 12 from standing on scanning tracks of the cutting wire sections CL in the planarization. In such a situation, to prevent the cutting wire sections CL and the wafer supporting sections 12 from interfering with each other to disable the discharge machining, in this system, it is possible to insert the wafer supporting sections 12 from a position where the scanning track of the cutting wire sections CL is not interfered and support the semiconductor wafers. In this system, in the process in which the cutting wire sections CL cut off the portion connected by the semiconductor ingot, the wafer supporting sections 12 move to the outside of the machined grooves. Therefore, the wafer supporting sections 12 do not interfere with the scanning tracks of the cutting wire sections CL. The rigidity of the semiconductor wafers near a portion still connected by the semiconductor ingot is high, and the semiconductor wafer machined surfaces do not fluctuate, so that the fixing of the semiconductor wafers by the wafer supporting sections 12 is unnecessary.

Further, in a multi-wire discharge machining apparatus like the apparatus shown in FIG. 1 and FIG. 2, jetting ports of the nozzles 8a and 8b are arranged along the stretching direction of the cutting wire sections CL. The nozzles 8a and 8b form machining fluid flows in opposite directions toward the discharge gaps. Because the machining fluid is supplied from both sides of the machined grooves of the work piece 5, it is possible to remove machining chips from discharge gaps and supply new machining fluid even to long machined grooves.

By adopting the apparatus configuration explained above, the semiconductor wafers being machined do not vibrate and the discharge gaps between the cutting wire sections CL and the semiconductor wafer machined surfaces do not fluctuate. Therefore, the discharge machining is stabilized. It is possible to machine highly accurate semiconductor wafers having the same plate thickness on high-quality semiconductor wafer machined surfaces.

Each of the respective cutting wire sections CL has an impedance due to electric resistance or the like of the wires 3 between the cutting wire sections CL and the cutting wire sections CL adjacent thereto. To keep independency of the cutting wire sections CL, it is undesirable that conduction routes other than the cutting wire sections CL are formed. Therefore, the bundle-like portions 13 of the wafer supporting sections 12, which are inserted into the gaps between the semiconductor wafers and in contact with the semiconductor wafers, need to be made of an insulating material.

Because machining speed does not depend on the hardness of the work piece 5, the wire discharge machining is particularly effective for a material having high hardness. For the work piece 5, for example, metal such as tungsten or molybdenum to be a sputtering target, ceramics such as polycrystalline silicon carbide used for various structural members, monocrystalline silicon or monocrystalline silicon carbide to be a semiconductor wafer for semiconductor device manufacturing, a semiconductor material such as gallium nitride, and monocrystalline or polycrystalline silicon to be a wafer for a solar cell can be adopted. In particular, concerning the silicon carbide and the gallium nitride, because hardness is high, there is a problem in that productivity is low and machining accuracy is low in a system by a mechanical wire saw. The present invention is suitable for manufacturing semiconductor wafers of the silicon carbide or the gallium nitride while attaining high productivity and high machining accuracy.

The configuration explained above includes the wafer supporting sections 12. The gaps between the semiconductor wafers are stuffed to fix the semiconductor wafers. Therefore, even when the cutting wire sections CL are repeatedly scanned and a large-diameter semiconductor wafer is subjected to finishing discharge machining, it is possible to prevent the semiconductor wafers from vibrating or tilting. It is possible to prevent vibration of the semiconductor wafers cut off from the semiconductor ingot to stably maintain the discharge gaps, and perform stable discharge machining even on wire scanning tracks on which the discharge gaps between the cutting wire sections CL and the semiconductor wafer surfaces are further reduced. Therefore, there is an effect that it is possible to simultaneously manufacture a plurality of high-quality semiconductor wafers finished at a dimension close to a final plate thickness in which surface roughness and flatness are satisfactory, there is no damaged layers, and plate thickness variation in the semiconductor wafers and between the semiconductor wafers is small.

The wafer supporting sections 12 in the configuration explained above are inserted into the gaps between the semiconductor wafers from the direction substantially parallel to the traveling direction of the cutting wire sections CL. Therefore, the wafer supporting sections 12 are inserted from a direction in which the machining fluid is supplied. Because a flow of the machining fluid discharged from the gaps between the semiconductor wafers to the outside is not hindered, the semiconductor wafers do not fluctuate because of fluctuation in the machining fluid flow. Machining chips can be efficiently discharged from the discharge gaps. Therefore, because the discharge gaps do not fluctuate either, stable discharge machining can be performed. There is an effect that it is possible to simultaneously manufacture a plurality of high-quality semiconductor wafers finished at a dimension close to a final plate thickness in which surface roughness and flatness are satisfactory, there is no damaged layers, and plate thickness variation in the semiconductor wafers and between the semiconductor wafers is small.

In the inserting method for the wafer supporting sections 12 into the semiconductor wafers being machined from the semiconductor ingot, even when the cutting wire sections CL planarize the semiconductor wafer machining start section, the scanning tracks of the cutting wire sections CL are not hindered. Therefore, it is possible to perform stable discharge machining. There is an effect that it is possible to simultaneously manufacture a plurality of high-quality semiconductor wafers finished at a dimension close to a final plate thickness in which surface roughness and flatness are satisfactory, there is no damaged layers, and plate thickness variation in the semiconductor wafers and between the semiconductor wafers is small.

By using the wire discharge machining apparatus that attains the effect explained above, it is possible to cut the work piece 5, which includes a hard material such as silicon carbide or gallium nitride, in a thin plate shape with high productivity.

When an ingot not subjected to the outer circumference polishing for forming orientation flat surfaces is used for machining, orientation flat surfaces can be formed when the connecting portion is segmented. That is, it is also possible that, after the finishing process, the wires 3 are arranged in the positions where the cut-out of the semiconductor wafers is suspended, cutting by the discharge machining is performed in the direction orthogonal to the traveling direction in the cutting process for the wires to cut off the semiconductor wafers from the work piece, and cut-off portions are formed as the orientation flat surfaces. Consequently, it is possible to simultaneously realize the segmentation and the formation of the orientation flat surface.

### Third Embodiment

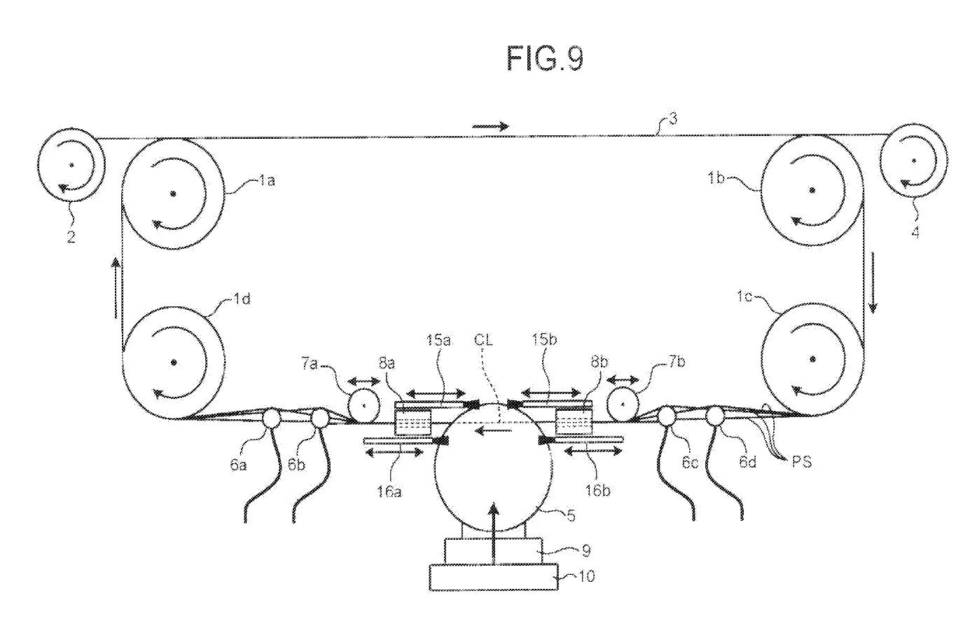

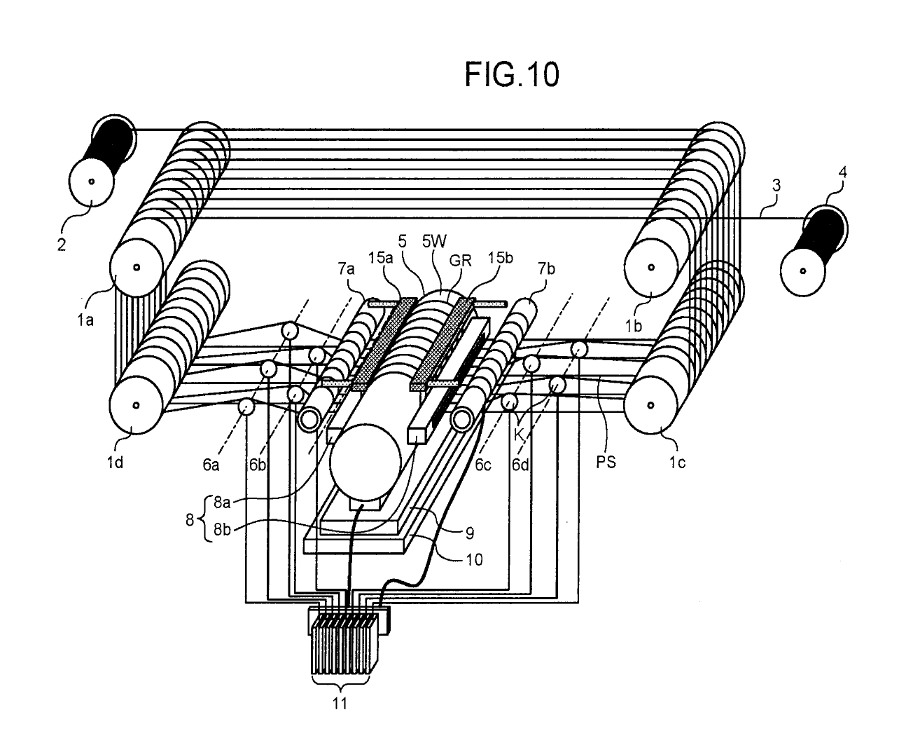

FIG. 9 is a side view of the configuration of a main part of a wire discharge machining apparatus according to a third embodiment of the present invention. FIG. 10 is a schematic perspective view of the wire discharge machining apparatus. The wire discharge machining apparatus in the first embodiment includes the main guide rollers 1c and 1d functioning as a pair of guide rollers disposed in parallel at intervals, one wire 3 that is wound between the pair of main guide rollers 1c and 1d a plurality of times while being spaced apart from each other at a fixed pitch to form a parallel wire section PS between the pair of main guide rollers 1c and 1d and travels according to the rotation of the main guide rollers 1c and 1d, a pair of the damping guide rollers 7a and 7b that are provided between the pair of main guide rollers 1c and 1d, follow and come into contact with the parallel wire section PS, and forms a plurality of the cutting wire sections CL to be damped, a plurality of power feed terminals (the power feed terminal units 6a to 6d) that feed electric power respectively to the cutting wire sections CL, a section that moves the work piece 5 relatively to the cutting wire sections CL in a parallel arrangement direction of the wires 3 forming the cutting wire sections CL and a direction perpendicular to the parallel arrangement direction of the wires 3 forming the cutting wire sections CL, cutting-time wafer supporting sections 15a and 15b and finishing-time wafer supporting sections 16a and 16b that are parallel to a stretching direction of the cutting wire sections CL, disposed on both sides of the work piece 5, and move substantially in parallel to the stretching direction of the cutting wire sections CL, and wafer-supporting-section insertion control plates 18a and 18b that control behavior for bringing the cutting-time wafer supporting sections 15a and 15b, and the finishing-time wafer supporting sections 16a and 16b close to and away from the work piece 5. The cutting wire sections CL are characterized by including a function of simultaneously cutting the work piece 5 into a plurality of wafers 5W with energy due to electric discharge between the cutting wire sections CL and the work piece 5 supported by the cutting-time wafer supporting sections 15a and 15b and a function of simultaneously finishing the surfaces of the wafers 5W with energy due to electric discharge between the cutting wire sections CL and the work piece 5 supported by the finishing-time wafer supporting sections 16a and 16b. Reference numeral 11 denotes a power supply unit. The power supply unit 11 feeds electric power to each of the sections to execute respective functions and drives the sections.

The cutting-time wafer supporting sections 15a and 15b and the finishing-time wafer supporting sections 16a and 16b include the thin line bundle sections 13 functioning as inserting sections that are inserted into the machined grooves GR, which are formed by cutting and function as inter-wafer regions, and retain a wafer interval, the insertion supporting sections 14 that support the thin line bundle sections 13, and the rolling rollers 17 connected to the insertion supporting sections 14. The rolling rollers 17 roll along the surface shape of the wafer-supporting-section insertion control plates 18a and 18b, whereby an insertion amount of the thin line bundle sections 13 into the machined grooves GR formed in the work piece 5 is controlled.

The main guide rollers 1a to 1d are major guide rollers that configure a wire traveling system. In the wire discharge machining apparatus, four main guide rollers 1a to 1d having the same diameter are arranged in parallel spaced apart from one another. One wire 3 let out from the wire delivering bobbin 2 is repeatedly wound on (wound around) the four main guide rollers 1a to 1d while being spaced apart at a fixed pitch. The wire 3 travels according to the rotation of the main guide rollers 1a to 1d and finally reaches the wire winding bobbin 4. The main guide rollers 1c and 1d are set in positions interposing across the work piece 5 therebetween. The wires 3 are stretched between the main guide rollers 1c and 1d at fixed tension, whereby a plurality of parallel wire sections PS spaced apart in the axial direction of the main guide rollers 1c and 1d are formed. Note that, in this specification, the parallel wire section PS indicates a portion from letting-out of the wires 3 from the main guide roller 1c until winding of the wires 3 on the main guide roller 1d. Within the parallel wire section PS, linearly stretched regions including a portion opposed to the work piece 5 are the cutting wire sections CL. FIG. 9 is a state in which cutting of the work piece 5 is started and the cutting wire sections CL advance into the inside of the work piece 5.

The power feed terminal units 6a to 6d arranged in contact with the parallel wire section PS individually supply voltage pulses from a machining power supply to the cutting wire sections CL. In FIG. 9, two power feed terminal units are arranged. The damping guide rollers 7a and 7b are arranged on the parallel wire section PS between the power feed terminal units 6a and 6d. The damping guide rollers 7a and 7b guide the wires 3 while maintaining a state in which the wires 3 are always wound on the damping guide rollers 7a and 7b. The damping guide rollers 7a and 7b are guide rollers that are provided between the pair of main guide rollers 1c and 1d, follow and come into contact with the parallel wire section PS, and have a small diameter compared with the diameter of the main guide rollers 1c and 1d. The damping guide rollers 7a and 7b support the wires 3 and form a plurality of cutting wire sections CL in which the wires 3 are linearly stretched. As explained below, in the cutting wire sections CL between the damping guide rollers 7a and 7b, wire vibration is suppressed and a traveling position is substantially stationary.

Further, nozzles 8 (8a and 8b) are arranged in the region of the cutting wire sections CL. Machining fluid is jetted from the nozzles 8a and 8b, which are arranged to be opposed to each other, to cut portions of the work piece 5 along the cutting wire sections CL. The cutting wire sections CL pierce through the nozzles 8a and 8b but are not in contact with the inner surfaces of the nozzles 8a and 8b. The lifting and lowering stage 10 is a stand that places the work piece 5 and performs lifting and lowering of the work piece 5. An arrow drawn from the lifting and lowering stage 10 indicates a moving direction of the lifting and lowering stage 10. Whereas the lifting and lowering stage 10 performs lifting and lowering of the work piece 5, the wafer-parallel-direction moving stage 9 moves the work piece 5 in a direction in which the wires of the cutting wire sections CL are arranged in parallel, that is, a direction in which a plurality of the wafers 5W to be machined by the cutting wire sections CL are arranged in parallel.

The wire 3 is wound on each of the main guide rollers 1a to 1d by a part (about ¼) of the roller outer circumference. The wire 3 turns around all the four main guide rollers 1a to 1d. The main guide rollers 1a to 1d form a route reaching from the wire delivering bobbin 2 to the wire winding bobbin 4. The main guide rollers 1a to 1d are configured to secure a space for the work piece 5 to pass the cutting wire sections CL and not to interfere with the other wires 3. The main guide rollers 1c and 1d are driving guide rollers. The main guide rollers 1a and 1b arranged above the main guide rollers 1c and 1d are driven guide rollers. Whereas the driving guide roller is driven to rotate with a shaft thereof connected to a motor, the driven guide roller rotates according to wire traveling without generating a driving force. The damping guide rollers 7a and 7b are driven guide rollers arranged to come into contact with the parallel wire section PS such that the wire 3 is wound on the damping guide rollers 7a and 7b. The damping guide rollers 7a and 7b are driven according to the traveling of the wire 3 to rotate. In FIG. 9, arrows drawn around the axes of the main guide rollers 1a to 1d indicate rotating directions of the main guide rollers. An arrow drawn along the wire 3 indicates a traveling direction of the wire 3.

The main guide rollers 1a to 1d are rollers formed by winding, for example, urethane rubber around columnar cored bars. The main guide rollers 1a to 1d are rotatable with both ends of the cored bars supported by bearings. A high coefficient of friction of the rubber against the wires 3 is suitable for preventing the wires 3 from slipping on the main guide rollers 1a to 1d. On the roller surfaces of the main guide rollers 1a to 1d that the wires 3 come into contact, a plurality of grooves are formed at an interval same as a wire winding pitch. The wires are wound in the respective grooves. In this case, a distance (a winding pitch) between the cutting wire sections CL arranged in parallel at an equal interval is fixed. In the case of the wafers 5W, the distance is, for example, about 0.1 millimeter to 0.8 millimeter. In the driving main guide rollers 1c and 1d, a force for pulling the wires 3 can be obtained. In the driven main guide rollers 1a and 1b, a rotating force for rotating the rollers can be obtained. The guide rollers and the work piece 5 are immersed in the machining fluid. The cutting wire sections CL are opposed to the work piece 5 in the machining fluid. The cutting wire sections CL simultaneously perform cutting in parallel.

The damping guide rollers 7a and 7b are explained. The damping guide rollers 7a and 7b are driven guide rollers having high shape accuracy, high rotation accuracy, and high attachment accuracy compared with the main guide rollers 1a to 1d. Two damping guide rollers are used in places across the work piece 5. The damping guide rollers 7a and 7b are pushed into the stretched parallel wire section PS such that the wire 3 is wound on a part of the outer circumference of the damping guide rollers 7a and 7b. As a result, the wires between the damping guide rollers 7a and 7b are linearly stretched and the traveling direction of the wire 3 is bent. During the traveling of the wire 3, a state in which the wire 3 is wound on the damping guide rollers 7a and 7b is always maintained. When the wire 3 involving vibration before being wound on the damping guide roller 7b is surely wound on the damping guide roller 7b, the vibration of the wire traveling with vibration is blocked. Similarly, vibration applied to the wire 3 delivered from the damping guide roller 7a is blocked by the damping guide roller 7a. As a result, the two damping guide rollers 7a and 7b create, while rotating with a frictional force against the wire 3 according to the wire traveling, a state in which there is almost no wire vibration in a linear region between the damping guide rollers. That is, vibration propagation from the main guide rollers to the cutting wire sections CL is suppressed by the damping guide rollers 7a and 7b. It is possible to precisely guide the wire 3 to fix a microscopic traveling position.

The damping guide rollers 7a and 7b bend the traveling direction of the wire 3 extending to the cutting wire sections CL. However, the damping guide rollers 7a and 7b do not have action for securing a space for the work piece 5 to pass the cutting wire sections CL. On the roller surface that the wires 3 come into contact, there are grooves for wire guidance having an interval same as the interval of the cutting wire sections CL. The wires are wound in the grooves one by one. Arrows in the left-right direction on the damping guide rollers 7a and 7b shown in FIG. 9 indicate movable directions of the damping guide rollers 7a and 7b on the apparatus.

The power feed terminal units 6a and 6b are aggregates of power feed terminals K aligned at an interval same as the winding pitch of the wires 3. The power feed terminals K are insulated from one another. Electric power is fed to the cutting wire sections CL from the power feed terminals K. Machining currents respectively flow to the cutting wire sections CL. For the power feed terminals K, for example, power feed terminals attached with groove-like wire guides and formed in a circular shape or an arcuate shape in cross section are used. The power feed terminals K are rotatably set to be periodically rotated to change a wire contact part.

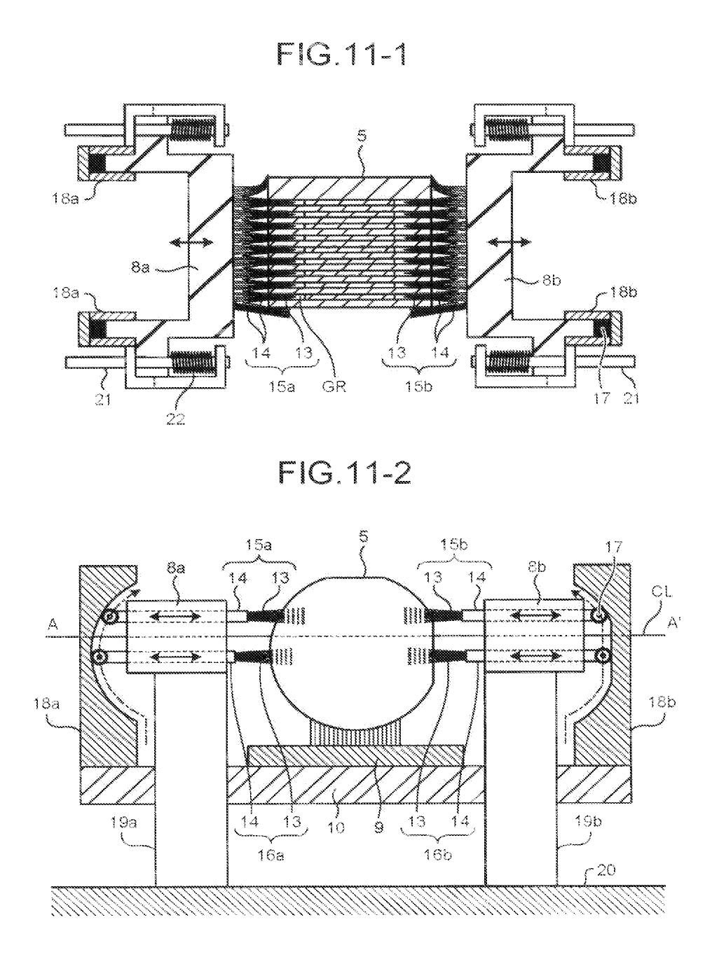

The cutting-time wafer supporting sections 15a and 15b and the finishing-time wafer supporting sections 16a and 16b are explained. FIG. 11-1 and FIG. 11-2 are external views of the structure of the cutting-time wafer supporting sections 15a and 15b and the finishing-time wafer supporting sections 16a and 16b. FIG. 11-2 is a front view. FIG. 11-1 is a sectional view cut along A-A′ in FIG. 11-2. The cutting-time wafer supporting sections 15a and 15b and the finishing-time wafer supporting sections 16a and 16b are configured by the thin line bundle sections 13 and the insertion supporting sections 14, both of which function as inserting sections. The thin line bundle sections 13 and the insertion supporting sections 14 are directly connected. The lengths of the thin line bundle sections 13 and the insertion supporting sections 14 of the cutting-time wafer supporting sections 15a and 15b and the finishing-time wafer supporting sections 16a and 16b are equal to each other. Further, the thin line bundle sections 13 are configured by aggregates of thin lines having a line diameter of about several ten micrometers and a line length of about 30 millimeters. The thin line bundle sections 13 are made of a nonconductive material having high flexibility and strength enough for not being deformed by the own weight. For example, a brush made of nylon and the like corresponds to the thin line bundle sections 13. Besides, the thin line bundle sections 13 can be made of a material easily deformable and having a high elastic force. For the inserting sections, the thin line bundle sections are used. However, the inserting sections are not limited to the thin line bundle sections as long as the inserting sections are made of a material having strength and flexibility. A mesh, an elastic body, and the like are also applicable.

On the side of the insertion supporting sections 14 where the thin line bundle sections 13 are not attached, the rolling rollers 17 are attached. The rolling rollers 17 are pressed against the wafer-supporting-section insertion control plates 18a and 18b. The wafer-supporting-section insertion control plates 18a and 18b are fixed to the lifting and lowering stage 10. The cutting-time wafer supporting sections 15a and 15b and the finishing-time wafer supporting sections 16a and 16b are set in substantially parallel to each other such that the cutting wire sections CL travel therebetween. In FIG. 10, only the cutting-time wafer supporting sections 15a and 15b are shown, but the finishing-time wafer supporting sections 16a and 16b are not shown. Columns 19a and 19b are fixed to a base 20. The cutting-time wafer supporting sections 15a and 15b and the finishing-time wafer supporting sections 16a and 16b are attached in a direction parallel to guide shafts 21 by the guide shafts 21 and springs 22 attached to the columns 19a and 19b. The springs 22 are set in a direction parallel to the length direction of the guide shafts 21.

The operation of the wire discharge machining apparatus in this embodiment is explained. Wire discharge machining is machining for causing arc discharge in very small discharge gaps between the wires 3 and the work piece 5 immersed in the machining fluid such as deionized water and cutting the work piece 5. Specifically, the surface of the work piece 5 is heated by arc generated on the surface of the work piece 5 and a part of the work piece 5 reaching temperature equal to or higher than a melting point of the work piece 5 vaporizes. The machining fluid present in the discharge gaps explosively vaporizes to blow off a melted portion of the work piece 5 with explosive power. The blown-off portion floats in the machining fluid as machining chips. Because the cutting wire sections CL and the work piece 5 are respectively discharge electrodes, the length of the discharge gaps is also referred to as inter-electrode distance.

In the third embodiment, a manufacturing method for semiconductor wafers using the apparatus includes a cutting step for performing cutting not to completely cut a plurality of the wafers 5W cut out from the work piece 5 by discharge machining of a plurality of the cutting wire sections CL and to leave a connecting portion in a state in which a part of the wafers 5W is integrated with the work piece 5, a first finishing step for bringing the cutting wire sections CL respectively close to first surface sides of the wafers 5W formed at the cutting step, scanning all the first surfaces, which are one-side surfaces of the wafers 5W, while applying discharge machining the first surfaces, and simultaneously finishing the first surfaces for all the wafers 5W, and a second finishing step for bringing the cutting wire sections CL close to the other-side surfaces of the wafer, scanning all the one-side surfaces of the wafers 5W while applying discharge machining thereto, and simultaneously finishing second surfaces for all the wafers 5W. The method includes a connecting-portion removing step for removing the connecting portion after the second finishing step. A plurality of semiconductor wafers are formed from an ingot.

During the machining, the wires 3 are continuously let out from the wire delivering bobbin 2, travel according to the rotation of the main guide rollers 1a to 1d, and are discharged to the wire winding bobbin 4. Tension during the traveling of the wires 3 arranged in parallel is controlled by respectively adjusting the rotating speed of the wire delivering bobbin 2 and that of the wire winding bobbin 4. When a traveling state of the wires 3 is stable, the tension of the traveling wires 3 is kept fixed.

When discharge machining is performed, while the main guide rollers 1c and 1d are rotated to cause the wires 3 to travel, after the work piece 5 is arranged to be opposed to the cutting wire sections CL at a predetermined distance apart therefrom, a voltage pulse is applied to the cutting wire sections CL. The lifting and lowering stage 10 is lifted according to cutting speed. In a state in which the inter-electrode distance is kept fixed, the arc discharge is continued by relatively moving the parallel cutting section and the work piece 5. The machined grooves GR are formed to correspond to the routes on which the cutting wire sections CL pass in the work piece 5. Therefore, the thickness of the wafers 5W to be cut out is a length obtained by subtracting the width (machining width) of the machined grooves GR, which are cutting margins of the work piece 5, from a winding pitch. To reduce the machining width, the line diameter of the wires 3 is desirably small. Practically, a steel wire having a diameter of about 0.1 millimeter is appropriate. Preferably, a wire further reduced in diameter to, for example, 0.07 millimeter is used. Further, to set an appropriate discharge start voltage, coating of brass or the like can be applied to the surface of the steel wire.

To adjust a pressing amount of the power feed terminal units 6a and 6b against the cutting wire sections CL, a not-shown mechanism for moving the power feed terminal units 6a and 6b in a direction perpendicular to the wires is provided. A contact length of the wires 3 and the power feed terminals K is a sliding length. The sliding length can be managed according to a pressing amount of the power feed terminal units 6a and 6b against the parallel wire section PS. That is, if the pressing amount is small, the sliding length is small. If the pressing amount is large, the sliding length is large. The pressing amount can be specified by a push-in distance to the wires 3 or can be specified by a pressing force against the wires 3. By adjusting the sliding length, contact resistance can be adjusted and a discharge current value per one voltage pulse can be finely adjusted. Note that, naturally, because electric power is fed to the cutting wire sections CL via the power feed terminal units 6a and 6b, the machining current value can also be adjusted by adjusting a machining power supply.

The operation of the cutting-time wafer supporting sections 15a and 15b and the finishing-time wafer supporting sections 16a and 16b is explained. As shown in FIG. 11-1, the wafer supporting sections 15a, 15b, 16a, and 16b are regulated by the guide shafts 21 such that the wafer supporting sections 15a, 15b, 16a, and 16b slides in the stretching direction of the cutting wire sections CL. Further, the wafer supporting sections 15a, 15b, 16a, and 16b are always pushed in to the opposite side of a setting direction of the work piece 5. Therefore, the rolling rollers 17 are always pressed against the wafer-supporting-section insertion control plates 18a and 18b. Surfaces of the wafer-supporting-section insertion control plates 18a and 18b against which the rolling rollers 17 are pressed have a similar shape to a contour shape of the work piece 5 to which the cutting-time wafer supporting sections 15a and 15b or the finishing-time wafer supporting sections 16a and 16b connected to the rolling rollers 17 are opposed. When the lifting and lowering stage 10 moves up and down, because the wafer-supporting-section insertion control plates 18a and 18b are fixed to the base 20 via the columns 19a and 19b, the rolling rollers 17 roll while rotating along the surfaces of the wafer-supporting-section insertion control plates 18a and 18b. The rolling rollers 17 roll along undulation shapes of the surfaces of the wafer-supporting-section insertion control plates 18a and 18b with which the rolling rollers 17 are in contact, whereby the undulations of the surface of the wafer-supporting-section insertion control plates 18a and 18b are converted into displacements in the horizontal direction. Therefore, the displacements corresponding to the undulation shapes of the surfaces of the wafer-supporting-section insertion control plates 18a and 18b are transmitted to the insertion supporting sections 14 and are transmitted to the thin line bundle sections 13. Therefore, the cutting-time wafer supporting sections 15a and 15b and the finishing-time wafer supporting sections 16a and 16b are inserted into or pulled out from the work piece 5 according to an external contour shape of the work piece 5. Depth of insertion of the thin line bundle sections 13 of the finishing-time wafer supporting sections 16a and 16b into the machined grooves GR formed in the work piece 5 is associated with a push-in operation and a retracting operation of the cutting-time wafer supporting sections 15a and 15b and the finishing-time wafer supporting sections 16a and 16b, and is controlled according to the displacements in the horizontal direction that occur when the rolling rollers 17 roll along the undulation shapes of the wafer-supporting-section insertion control plates 18a and 18b. The wafer-supporting-section insertion control plates 18a and 18b are similar to the external contour shape of the work piece 5. Therefore, an insertion amount of the thin line bundle sections 13 into the machined grooves GR formed in the work piece 5 is always fixed. Note that the cutting-time wafer supporting sections 15a and 15b and the finishing-time wafer supporting sections 16a and 16b can be independently inserted and pulled out.

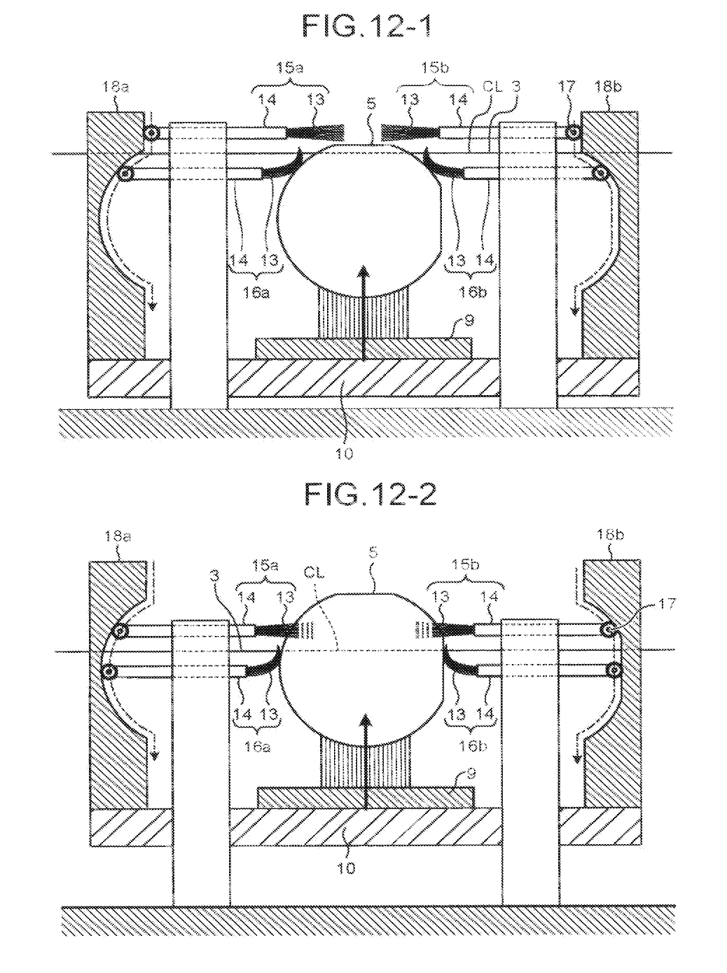

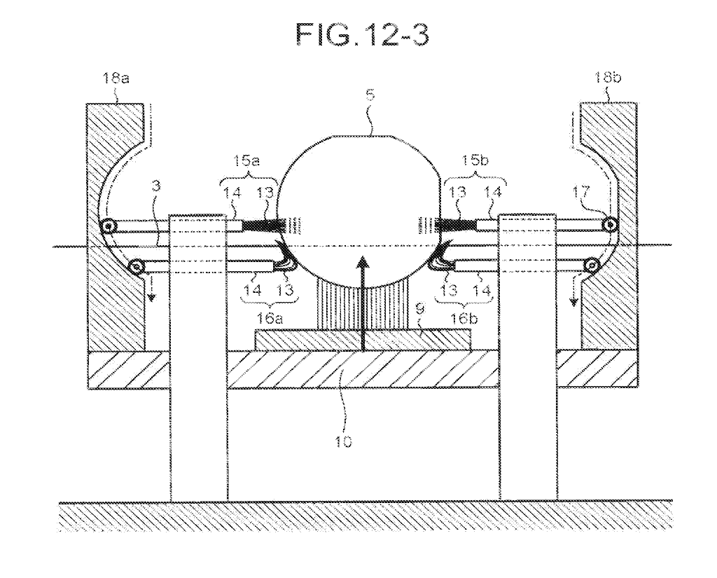

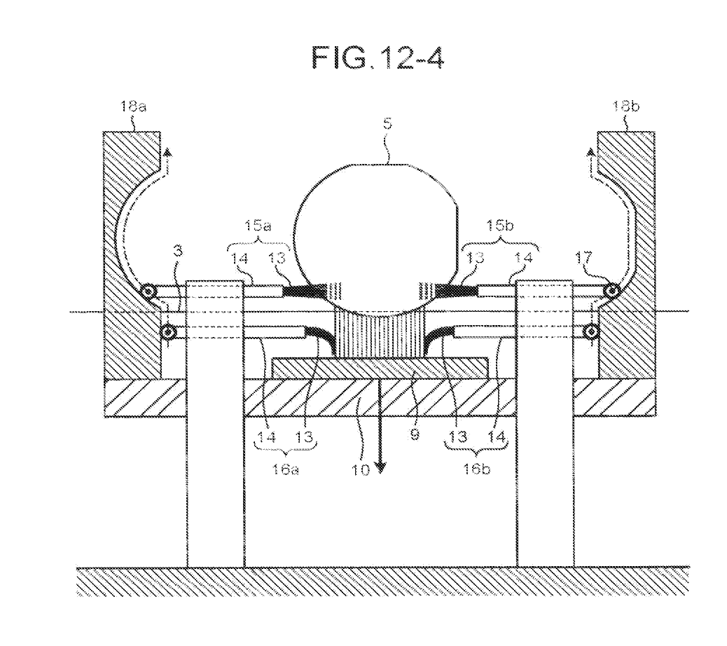

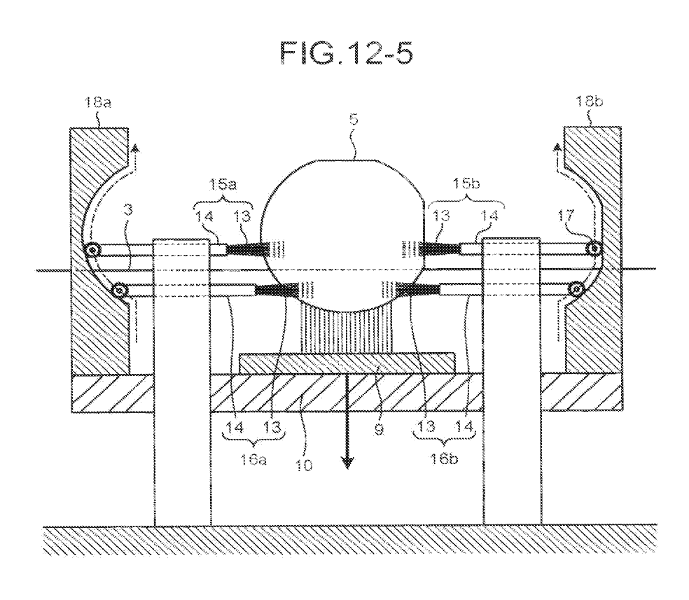

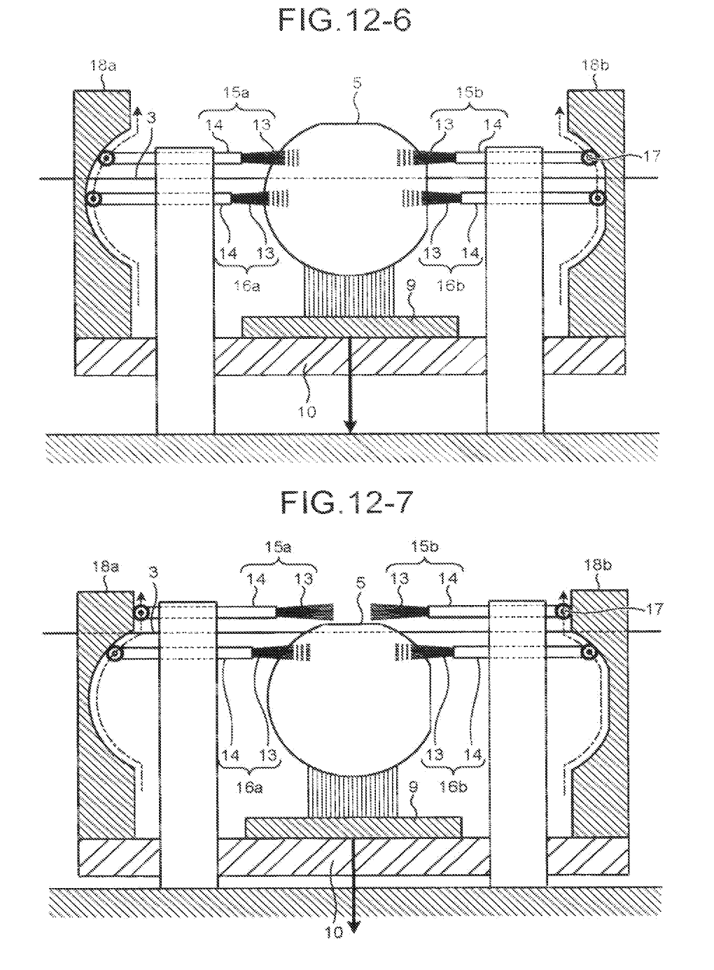

Behavior of the cutting-time wafer supporting sections 15a and 15b and the finishing-time wafer supporting sections 16a and 16b in the cutting and the finishing of the work piece 5 is explained with reference to FIGS. 12-1 to 12-7. As explained above, the cutting-time wafer supporting sections 15a and 15b and the finishing-time wafer supporting sections 16a and 16b are inserted and pulled out according to the external contour shape of the work piece 5. However, during wafer cutting from the work piece 5, which is the ingot, machined grooves into which the thin line bundle sections 13 of the finishing-time wafer supporting sections 16a and 16b are inserted are not formed yet. Therefore, the thin line bundle sections 13 of the finishing-time wafer supporting sections 16a and 16b are deformed, with flexibility thereof, along the outer surface of the work piece 5 and trace the outer surface of the work piece 5 according to the operation of the lifting and lowering stage 10. On the other hand, the respective thin line bundle sections 13 of the cutting-time wafer supporting sections 15a and 15b are inserted into the machined grooves GR formed by the discharge machining of the cutting wire sections CL located ahead in a machining direction. The thin line bundle sections 13 stuff up the gaps between a plurality of wafers formed from the work piece 5 and prevent vibration while retaining the wafers.

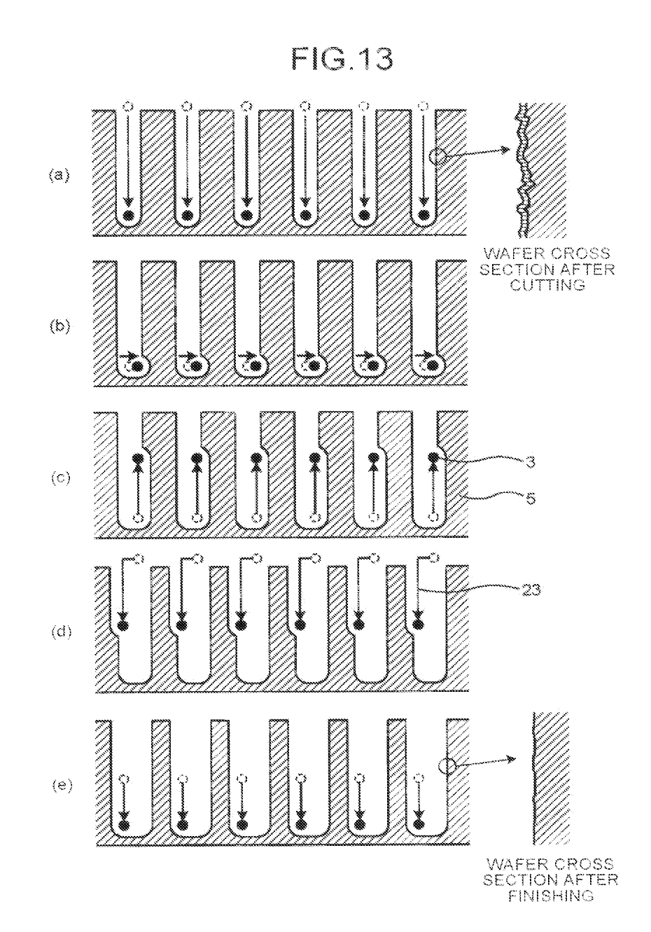

FIG. 13 shows a process for gradually machining wafers from the work piece 5, slightly moving the cutting wire sections CL in a wafer parallel arrangement direction immediately before the work piece 5 is completely cut, and, while repeating the scanning of wafer surfaces while discharge-machining the wafer surfaces to remove damaged layers, improving surface roughness and finishing a plate thickness to a predetermined dimension. In the finishing of the wafer surfaces shown in FIG. 13(b) to FIG. 13(c) after the cutting of the work piece 5 is performed in FIG. 13(a), because the machined grooves GR are formed in the work piece 5, the thin line bundle sections 13 of the cutting-time wafer supporting sections 15a and 15b and the finishing-time wafer supporting sections 16a and 16b are inserted into the machined grooves GR. During the relative movement of the cutting wire sections CL on the inside of the machined grooves GR, the wafers being machined are retained by the cutting-time wafer supporting sections 15a and 15b and the finishing-time wafer supporting sections 16a and 16b located in the front and the back of the cutting wire sections CL. Therefore, vibration of the wafers is prevented. Note that the distance of the cutting-time wafer supporting sections 15a and 15b and that of the finishing-time wafer supporting sections 16a and 16b to the cutting wire sections CL are adjusted and set to the distance for preventing the thin line bundle sections 13 from interfering with the cutting wire sections CL even if the thin line bundle sections 13 are deformed.

As explained above, the thin line distal ends bound in the thin line bundle sections 13 included in the cutting-time wafer supporting sections 15a and 15b and the finishing-time wafer supporting sections 16a and 16b are inserted into the gaps between the wafers having narrow intervals because of flexibility thereof. The wafers are stuffed in a wedge shape by the inserted thin lines of the thin line bundle sections 13. The cutting-time wafer supporting sections 15a and 15b and the finishing-time wafer supporting sections 16a and 16b are set substantially in parallel from the stretching direction of the wires 3 toward the gaps between the wafers, that is, the machined grooves GR, from both side directions of the wafers interposing the ingot, which is the work piece 5, and in the front and the back in the relative machining direction of the cutting wire sections CL. Consequently, wafer vibration is prevented, the discharge machining is stabilized in the cutting and the finishing as well, and it is made possible to obtain high-quality wafers having a satisfactory machining surface characteristic and a uniform plate thickness.

An insertion amount of the thin-line bundle sections 13 depends on the shape of the surfaces of the wafer-supporting-section insertion control plates 18a and 18b on which the rolling rollers 17 travel while being in contact therewith. Therefore, by setting the surface shape of the wafer-supporting-section insertion control plates 18a and 18b to be the same as the contour shape of the work piece 5 to be machined, it is unnecessary to separately provide an expensive automatic stage for driving the cutting-time wafer supporting sections 15a and 15b and the finishing-time wafer supporting sections 16a and 16b. It is possible to easily realize the behavior of insertion and pull-out corresponding to the size and the shape of wafers being machined in the vicinity of the position where the work piece 5 is machined by the cutting wire sections CL. For example, when the work piece 5 is changed from a 2-inch ingot to a 6-inch ingot, as the surfaces of the wafer-supporting-section insertion control plates 18a and 18b on which the rolling rollers 17 roll, surfaces adjusted to the external shape of the ingot only have to be prepared. Even if an orientation flat position of the ingot changes, by preparing the wafer-supporting-section insertion control plates 18a and 18b simulating that state, it is possible to easily adjust appropriate insertion and pull-out. For example, the wafers are fixed to prevent vibration while the insertion supporting sections 14 that retain the thin line bundle sections 13 of the finishing-time wafer supporting sections 16a and 16b are operated to insert the thin line bundle sections 13 into and pull out the thin line bundle sections 13 from the wafers. The inserting and pull-out operations of the finishing-time wafer supporting sections 16a and 16b are performed according to a side surface shape of the ingot. For example, in an ingot having a circular cut surface, the insertion and the pull-out of the wafer supporting sections are performed according to a scanning position of the cutting wire sections CL with respect to wafer surfaces such that insertion depths of the thin line bundle sections 13 on the upper side and the lower side of the ingot are substantially fixed. That is, near a wafer cutting start or end part where a wire length in a cutting direction of wafers is short, the insertion supporting sections 14 are sent into the wafer side, whereby the thin line bundle sections 13 are pressed against the ingot and the distal ends of the finishing-time wafer supporting sections 16a and 16b are inserted into the gaps between the wafers. Near the centers of the wafers, the insertion supporting sections 14 are pulled out from the wafer side, whereby the thin line bundle sections 13 separate from the ingot. In an inserted state near the wafer cutting start or end part, the distal ends of the finishing-time wafer supporting sections 16a and 16b are operated to separate from the ingot, such that the distal ends are prevented from being excessively pushed into the machined grooves GR.

Fluctuation due to a swing of the entire wafers is larger at an end on the wafer machining start side. Therefore, when the cutting wire sections CL machine the vicinity of the end on the wafer machining start side, an inter-electrode distance most easily fluctuates. Therefore, when a scanning position of the cutting wire sections CL is present in the vicinity of the end on the wafer machining start side, the finishing-time wafer supporting sections 16a and 16b are inserted into the gaps between the wafers in a position about 10 millimeters away from the cutting wire sections CL to a connecting portion side where the wafers are connected by the ingot. The wafers are fixed by the wafer supporting sections inserted into the gaps between the wafers like wedges. The inter-electrode distance between the cutting wire sections CL and wafer machined surfaces is maintained fixed. Therefore, stable finishing discharge machining is performed.

The direction of the insertion or the pull-out of the finishing-time wafer supporting sections 16a and 16b is set to be substantially parallel to the direction in which the wires of the cutting wire sections CL are arranged in parallel. This is for the purpose of preventing, when the semiconductor wafers are held from the semiconductor wafer cutting start side, the finishing-time wafer supporting sections 16a and 16b from standing on scanning tracks of the cutting wire sections CL in the finishing. In such a situation, to prevent the cutting wire sections CL and the finishing-time wafer supporting sections 16a and 16b from interfering with each other to disable the discharge machining, in this system, it is possible to insert the finishing-time wafer supporting sections 16a and 16b from a position where the scanning tracks of the cutting wire sections CL are not interfered and support the wafers. In this system, at a point when the cutting wire sections CL machine a portion connected in a part of a region of the ingot, the finishing-time wafer supporting sections 16a and 16b are pulled out to the outer side of the machined grooves GR. Therefore, the finishing-time wafer supporting sections 16a and 16b do not interfere with the scanning tracks of the cutting wire sections CL. The rigidity of the wafers near a portion still connected by the semiconductor ingot is high. The semiconductor wafer machined surfaces do not fluctuate. Therefore, the fixing of the wafers by the finishing-time wafer supporting sections 16a and 16b is unnecessary.

Further, in a multi-wire discharge machining apparatus in the third embodiment shown in FIG. 9, jetting ports of the nozzles 8a and 8b are arranged along the stretching direction of the cutting wire sections CL. The nozzles 8a and 8b form machining fluid flows in directions opposite to each other toward the discharge gaps. Because the machining fluid is supplied from both sides of the machined grooves GR of the work piece 5, it is possible to remove machining chips from discharge gaps and supply new machining fluid even to the long machined grooves GR. While the machining fluid supplied from the nozzles 8a and 8b to the machined grooves GR formed in the ingot is discharged from the machined grooves GR on the wafer cutting start side together with the machining chips, the discharge machining progresses. However, when the wafer holding sections are inserted from the wafer cutting start side, a flow of the machining fluid changes, discharge efficiency of the machining chips is deteriorated, and the discharge machining becomes unstable. According to the third embodiment, the flow of the machining fluid is not prevented by the insertion of the finishing-time wafer supporting sections 16a and 16b. Further, because inserting directions of the two finishing-time wafer supporting sections 16a and 16b coincide with machining fluid supplying directions from the nozzles 8a and 8b, inserting members of the thin line bundle sections 13 of the finishing-time wafer supporting sections 16a and 16b are not moved in directions opposite to the inserting directions, and thus it is made possible to smoothly insert the inserting members into the gaps between the wafers.

Note that a track 23 of the cutting wire sections in the finishing discharge machining of the wafer surfaces in FIG. 13 is an example. For example, when machining shifts from a cutting process for the work piece 5 to a finishing process for the wafer surfaces, the cutting wire sections are not moved in a wafer parallel arrangement direction as shown in FIG. 13(b). After the cutting wire sections are returned to a cutting start position shown in FIG. 13(a), the cutting wire sections CL are brought close in the direction of the wafer surfaces to be finished and are scanned along the wafer surfaces on one side while the discharge machining is performed on the wafer surfaces according to finishing energy setting. Even when this is repeated, the cutting-time wafer supporting sections 15a and 15b and the finishing-time wafer supporting sections 16a and 16b hold the wafers. It is possible to stabilize the discharge machining and obtain high-quality wafers in the same manner.

By adopting the apparatus configuration explained above, the semiconductor wafers being machined from the work piece 5 do not vibrate and the inter-electrode distance between the cutting wire sections and the semiconductor wafer machined surfaces does not fluctuate. Therefore, the discharge machining is stabilized. It is possible to simultaneously obtain a large quantity of highly accurate wafers having satisfactory machined surface quality, high quality, and the same plate thickness. Therefore, it is possible to reduce loads of grinding and polishing, which are post processes of the wafer cutting, and reduce wafer costs.

Each of the cutting wire sections CL has impedance due to electric resistance or the like of the wires 3 between a cutting wire section CL and the cutting wire section CL adjacent thereto, and thus independency of the cutting wire sections CL is kept, so that it is undesirable that conduction routes other than the cutting wire sections CL are formed. Therefore, the bundle-like portions 13, which are bundle-like portions of the cutting-time wafer supporting sections 15a and 15b and the finishing-time wafer supporting sections 16a and 16b, inserted into the gaps between the wafers and coming into contact with the wafers are made of an insulating material.

Because machining speed does not depend on the hardness of the work piece 5, the wire discharge machining is particularly effective for a material having high hardness. As the work piece 5, for example, metal such as tungsten or molybdenum to be a sputtering target, ceramics such as polycrystalline silicon carbide used as various structural members, monocrystalline silicon or monocrystalline silicon carbide to be a wafer for semiconductor device manufacturing, a semiconductor material such as gallium nitride, and monocrystalline or polycrystalline silicon to be a wafer for a solar cell can be adopted. In particular, concerning the silicon carbide and the gallium nitride, because hardness is high, there is a problem in that productivity is low and machining accuracy is low in a system by a mechanical wire saw. On the other hand, according to this embodiment, it is possible to manufacture wafers of silicon carbide or gallium nitride while attaining both of high productivity and high machining accuracy. Because the cutting and the finishing can be realized by the same machining apparatus, useless polishing due to positional deviation or the like is unnecessary. This embodiment is particularly effective for machining of expensive wafers.

In the wire discharge machining apparatus in the third embodiment, the example is explained in which the one wire 3 is wound on the four main guide rollers 1a to 1d. However, for example, it is also possible to adopt a configuration in which three main guide rollers are arranged. Note that, in the wire discharge machining apparatus in the third embodiment, the adjacent wires are nearly insulated according to a resistance difference between the power feed terminals of the adjacent wires included in the parallel wire section PS. That is, a machining current is prevented from leaking (sneaking) to a discharging portion of the work piece 5 according to a resistance value proportional to a wire length between the power feed terminals. Therefore, when the wires are wound on a plurality of main guide rollers, the wires of one loop only have to be sufficiently long to increase the resistance difference between the power feed terminals. Besides, the wire discharge machining apparatus is not limited to the embodiment. A specific configuration of the wire discharge machining apparatus is not particularly limited as long as the parallel wire section PS are formed by repeatedly folding back the one wire 3.

In the method in the third embodiment, both the side surfaces of the wafers are finished. However, only one side surface can be finished depending on a type of a semiconductor device such as a device in which, after an element region is formed on one surface side and the device is formed, the rear surface side is thinned by polishing or etch-back to be used.

As explained above, according to the configuration of this embodiment, after the finishing of the wafer surfaces is completed, the portion (the connecting portion) slightly connected to the work piece 5 is cut. In the cutting, the discharge machining is performed while the cutting wire sections CL are reciprocatingly moved between the wafers and scanned in the depth direction of the machined grooves GR by the lifting and lowering moving stage 10 that lifts and lowers the work piece 5 in the cutting direction (the up-down direction) and the wafer-parallel moving stage 9 that moves the work piece 5 in the direction (the horizontal direction) in which the wafers formed by cutting the work piece 5 are arranged in parallel. In this case, the wire discharge machining apparatus includes the cutting-time wafer supporting sections 15a and 15b and the finishing-time wafer supporting sections 16a and 16b, wherein the machined grooves GR between the wafers are stuffed to fix the wafers. Therefore, even when not only the wafer cutting from the work piece but also the finishing discharge machining of the wafers is performed by repeatedly scanning the cutting wire sections CL, it is possible to prevent vibration or inclination of the wafers. Further, it is possible to suppress vibration of the wafers being machined from the ingot to stably maintain a discharge gaps. The wires are not short-circuited even on wire scanning tracks on which the inter-electrode distance between the cutting wire sections CL and the wafer surfaces is further reduced, and thus it is made possible to perform stable discharge machining. Therefore, there is an effect that it is possible to simultaneously manufacture a plurality of high-quality semiconductor wafers finished at a dimension close to a final plate thickness in which surface roughness and flatness are satisfactory, there is no damaged layers, and plate thickness variation in the semiconductor wafers and between the semiconductor wafers is small.

As in the case of the first embodiment, the wafer supporting sections in the configuration explained above are inserted into the gaps between the semiconductor wafers from the parallel arrangement direction of the cutting wire sections and the parallel direction. Therefore, the wafer supporting sections are inserted from a direction in which the machining fluid is supplied. A flow of the machining fluid discharged from the gaps between the semiconductor wafers to the outside is not hindered. Therefore, in the cutting and the finishing, the wafers do not fluctuate because of fluctuation in the machining fluid flow. Further, machining chips can be efficiently discharged from the discharge gaps, and thus the inter-electrode distance does not fluctuate and stable discharge machining can be performed. There is an effect that it is possible to simultaneously manufacture a plurality of high-quality semiconductor wafers finished at a dimension close to a final plate thickness in which surface roughness and flatness are satisfactory, there is no damaged layers, and plate thickness variation in the semiconductor wafers and between the semiconductor wafers is small.

In this embodiment, as in the first embodiment, a recess is formed in the wafer-parallel-direction moving stage 9 according to the external shape of the work piece. The work piece is enabled to slide only in a direction in which expansion is caused by cutting. Therefore, the work piece is cut while positional deviation is suppressed. After the cutting, the work piece is finished while the position of the work piece is maintained. That is, the cutting wafer supporting section and the finishing wafer supporting section are used during the cutting and during the finishing. The positions of the cutting wafer supporting section and the finishing wafer supporting section are enabled to move only in the longitudinal 30 direction of the ingot, and the cutting and the finishing are performed according to the up-down movement of the supporting sections. Therefore, it is possible to extremely efficiently carry out the cutting and the finishing for a large number of wafers at high accuracy.

The cutting-time wafer supporting section and the finishing-time wafer supporting section are inserted into the wafers being machined. Therefore, even when the cutting wire sections perform finishing discharge machining of the wafer machining start section, the scanning tracks of the cutting wire sections are not hindered, and thus it is possible to perform stable discharge machining. Therefore, there is an effect that it is possible to simultaneously manufacture a plurality of high-quality semiconductor wafers finished at a dimension close to a final plate thickness in which surface roughness and flatness are satisfactory, there is no damaged layers, and plate thickness variation in the semiconductor wafers and between the semiconductor wafers is small. Note that the configuration of the cutting-time wafer supporting sections and the finishing-time wafer supporting sections is not limited to the configuration in the embodiment, but only has to be a configuration in which the wafer interval can support the wafers to maintain the wafer interval.

As opposed to a state in which wafers are slightly connected to one another in an un-machined section of a work piece, it is also possible to, without folding back moving tracks of the cutting wire sections for the work piece, extend a track during machining of the work piece and simultaneously machine a plurality of wafers. That is, the wafer supporting sections are inserted into the gaps between the wafers, whereby the wafers are held. Therefore, a swing and a tilt that tend to occur, in particular, when large-diameter wafers are machined are eliminated. There is an effect the cutting until the completion of the wafer cutting is stabilized and machining accuracy of the cut wafers is improved.

By using the wire discharge machining apparatus that attains the effect explained above, it is possible to cut the work piece, which includes a hard material such as silicon carbide or gallium nitride, into a thin plate shape with high productivity.

As explained above, in the manufacturing method for semiconductor wafers using the wire discharge machining apparatus in this embodiment, in the wafer machining for simultaneously cutting a plurality of thin plates from an ingot, which is a work piece, according to the wire discharge machining in which the cutting wire sections including a plurality of wires arranged in parallel are used as electrodes, the finishing is performed to, in a state in which wafers are not completely cut and separated from the ingot and machined groove distal ends are slightly connected in the ingot, scan the cutting wire sections on wafer surfaces formed by the cutting up to that point while performing the wire discharge machining, gradually remove damaged layers on the wafer surfaces by repeating the scanning, and improve surface roughness of the wafer surfaces while forming a plate thickness in a predetermined dimension. In the scanning of the cutting wire sections for the wafers, the wires forming the cutting wire sections, which machine the wafers, are brought close to the wafer surfaces on the side for finishing from the wire tracks during the cutting. The cutting wire sections are simultaneously scanned while the discharge machining is performed along the wafer surfaces to be finished.

The wire discharge machining apparatus according to this embodiment includes a pair of main guide rollers disposed in parallel at intervals, one wire that is wound between the main guide rollers a plurality of times while being spaced apart from each other at a fixed pitch to form parallel wire sections between the main guide rollers and travels according to the rotation of the main guide rollers, a pair of the damping guide rollers that are provided between the pair of main guide rollers, follow and come into contact with the parallel wire sections, and forms a plurality of damped cutting wire sections, a plurality of power feed terminals that feed electric power respectively to the cutting wire sections, a machining power supply that applies a voltage between the power feed terminals and a work piece, a power feed line that connects the machining power supply and the power feed terminals and the work piece, a lifting and lowering stage for relatively moving an ingot, which is the work piece, and the cutting wire sections up and down, a wafer-parallel-direction moving stage for relatively moving the ingot and the cutting wire sections in a wafer parallel arrangement direction, and wafer supporting sections that suppress vibration of wafers.

According to this embodiment, as explained above, the wire discharge machining apparatus simultaneously cuts a plurality of wafers from an ingot, which is a work piece, with electric discharge caused in the cutting wire sections and, after bringing the cutting wire sections close to one wafer side by about several micrometers to ten micrometers before the machined wafers are completely cut and separated to be wafers, repeats scanning of the cutting wire sections on wafer surfaces being formed while performing discharge machining on the wafer surfaces to thereby remove damaged layers on surfaces to be the wafer surfaces, improve surface roughness, improve flatness of the wafer surfaces, and finish a plate thickness close to a requested dimension. In the wire discharge machining apparatus, the wafers that tend to fluctuate because of machining fluid and the own weight of the wafers are retained in predetermined positions during the discharge machining to prevent an inter-electrode distance between the cutting wire sections and the wafer machined surfaces from fluctuating. Consequently, it is made possible to stabilize the discharge machining in the cutting wire sections and obtain high-quality wafers.

According to this embodiment, it is possible to improve machining accuracy in simultaneous machining of a plurality of wafers from an ingot. The damaged layers on the wafer surfaces formed by the cutting are removed. It is possible to obtain, in one ingot cutting, a large quantity of high-quality wafers having satisfactory surface roughness and little fluctuation in a wafer plate thickness and close to final specifications. Therefore, it is possible to reduce loads in grinding and polishing in a wafer machining process after the cutting, reduce a total machining time required for the wafer machining and reduce a planning process, and attain a reduction in costs of the wafers.

However, the wire discharge machining apparatus in this embodiment is effective not only when a series of cutting and finishing are continuously performed in the same apparatus but also when only the cutting is performed. The wire discharge machining apparatus includes a unit that moves the work piece relatively to the cutting wire sections in a direction perpendicular to the parallel arrangement direction of the wires forming the cutting wire sections. Therefore, it is possible to highly accurately adjust the positions of cut surfaces and perform cutting while maintaining a highly accurate plate thickness. Even when only the finishing is performed, it is possible to perform alignment corresponding to conditions for the wafers.

### Fourth Embodiment

A configuration and an operation in a fourth embodiment of the present invention are explained. A wire discharge machining apparatus according to this embodiment forms orientation flat surfaces in segmenting a connecting portion. In this case, when an ingot not subjected to outer circumference polishing for forming the orientation flat surfaces is used for machining, the orientation flat surfaces can be formed when the connecting portion is segmented. In this embodiment, the wire discharge machining apparatus performs a first step for cutting an ingot to leave a connecting portion and forming a cut cross section, a second step of relatively moving wires in a direction approaching the cut cross section formed at the first step to perform finishing, and a fourth step of, after the second step, arranging the wires in positions where cut-out of the semiconductor wafers is suspended, performing cutting by discharge machining in a direction orthogonal to a traveling direction in a cutting process of the wires to cut off the semiconductor wafers from the work piece, and forming cut-off portions as the orientation flat surfaces. That is, after a finishing process, the wires 3 are arranged in the positions where the cut-out of the semiconductor wafers is suspended, the cutting by the discharge machining is performed in the direction orthogonal to the traveling direction in the cutting process of the wires to cut off the semiconductor wafers from the work piece, and the cut-off portions are formed as the orientation flat surfaces. Consequently, it is possible to simultaneously realize the segmentation and the formation of the orientation flat surfaces.

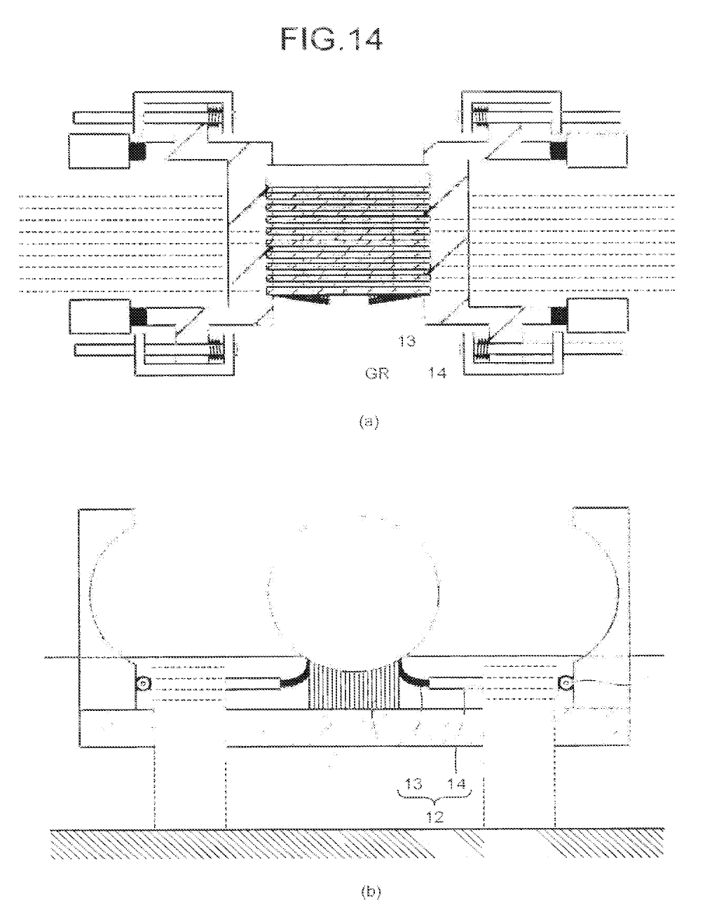

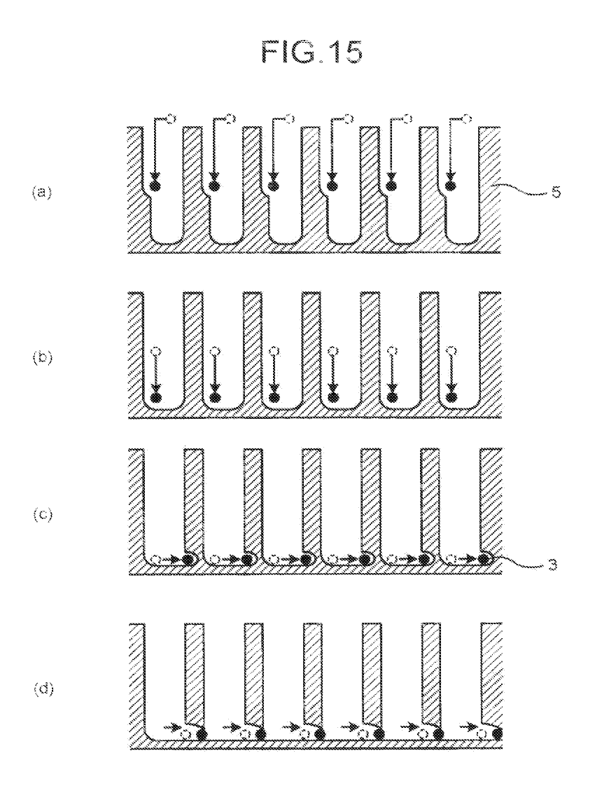

FIGS. 14(a) and 14(b) are external views of the positions and the operations of the wafer supporting section 12 and the work piece 5 during segmentation in the fourth embodiment. FIG. 14 (a) is a top view and FIG. 14(b) is a front view. FIG. 15 is an explanatory diagram of tracks of wires in planarization after cutting of semiconductor wafers by a wire discharge machining system and in cutting off the semiconductor wafers from a semiconductor ingot. The apparatus suppresses vibration of the semiconductor wafers and the like in processes of segmentation of the semiconductor wafers and planarization of cut surfaces using a discharge machining method and finally segmenting the semiconductor wafers while forming orientation flat surfaces. The apparatus prevents, for example, fluctuation of a substrate thickness and an external shape of the semiconductor wafers involved in the vibration. Concerning other cutting and the like by the discharge machining, because a configuration and an operation same as those in the first embodiment are used, explanation is omitted. The configuration and the operation of the wafer supporting section that suppresses vibration of the semiconductor wafers in a process for segmenting the semiconductor wafers while forming the orientation flat surfaces are mainly explained.

In this embodiment, as in the first embodiment, the wafer supporting sections 12 are configured by the thin line bundle sections 13 formed by bundling thin lines having a diameter of several ten micrometers and length of about 30 millimeters and the insertion supporting sections 14, which are handles for making it easy to insert the thin line bundle sections 13 into cut groove portions of a semiconductor ingot, which is the work piece 5. The wafer supporting sections 12 have a shape similar to a brush as a whole. For the thin lines forming the thin line bundle sections 13, thin lines made of resin such as nylon or polyacrylate, which is a nonconductive material having high flexibility and strength enough for not being deformed by the own weight, and machined in a piliform is used.

FIGS. 15(a) to 15(d) are explanatory diagrams of tracks of wires 3 of the cutting wire sections CL in cutting into semiconductor wafers, planarization, and segmentation by the wire discharge machining system. A cross section of the work piece 5 in a cut portion is shown. Black circles indicate the cross sections of the wires 3 of the cutting wire sections CL.

A pulse voltage is applied to the wires 3 of the cutting wire sections CL to cut the work piece 5 in the halfway. A cutting process is suspended in a position where several millimeters are left before completely cutting the work piece 5. Thereafter, while the pulse voltage is applied to the wires 3 of the cutting wire sections CL, the wires 3 are brought close in a direction of one-side cut surface by about several micrometers to 10 micrometers. Thereafter, the wires 3 are scanned in the upward direction in a discharge state. A discharge machining condition at this point is set slightly weaker than a discharge machining condition in the cutting process. Specifically, in this embodiment, the pulse voltage is set to 50 volts, which is a half of the pulse voltage in the cutting process. By repeating this (FIG. 15(a)), deformed layers of the cut cross sections can be removed and the cross sections can be planarized (FIG. 15(b)).

In this way, by performing the scanning with the wires 3 many times while causing electric discharge, unevenness of the damaged layers formed during the cutting is removed little by little and flat cut surfaces can be obtained. Because the cutting process is stopped and the cut surfaces are scanned and planarized directly using the wires used for the cutting while the semiconductor wafers being cut are kept attached in the apparatus, adjustment of positions such as alignment of orientations of machined surfaces of the semiconductor wafers is unnecessary during the planarization. It is possible to reduce a manufacturing process and obtain semiconductor wafers having satisfactory characteristics with high productivity.

After the planarization process of the cut surfaces ends, portions connected to the semiconductor ingot, which is the work piece 5, are cut off using the discharge machining method. First, the wires 3 are returned to the positions where the cutting process is suspended. After setting the wires 3 under a discharge machining condition same as that in the cutting, the work piece 5 is moved in a direction perpendicular to the paper surface of FIG. 14(b) and the semiconductor ingot and the semiconductor wafers are simultaneously cut.

In this way, as shown in FIG. 15(c), the wires 3 are caused to travel along the orientation flat surfaces and discharge machining energy larger than discharge machining energy when the cutting is applied to the semiconductor wafers to cut the semiconductor wafers in a short time. FIG. 15(d) is a diagram of a state during segmentation.

According to the process explained above, the process for cutting the semiconductor ingot, which is the work piece 5, is suspended. After the planarization of the cut surfaces is performed by the wires 3 of the cutting wire sections CL under a condition weaker than the discharge machining condition during the cutting, the wires are returned again to the position where the cutting is suspended and the connecting portion is cut while the orientation flat surfaces are formed. In this embodiment, it is possible to easily form orientation flats without separately adding a process. It is possible to insert the thin line bundle sections 13 of the wafer supporting sections 12 into the gaps between the semiconductor wafers 5 and suppress vibration. Therefore, it is possible to obtain satisfactory semiconductor wafers without substrate thickness variation of the semiconductor wafers due to vibration.

### INDUSTRIAL APPLICABILITY

As explained above, the wire discharge machining apparatus and the manufacturing method for semiconductor wafers according to the present invention are useful for manufacturing of a semiconductor device that forms semiconductor wafers from an ingot, particularly effective for improvement of productivity, and useful for formation of a thin silicon wafer or a compound semiconductor wafer that is expensive and easily warped or distorted and, in particular, wafers of a material having high hardness and poor machinability such as silicon carbide and gallium nitride.

### REFERENCE SIGNS LIST

1a Main guide roller
1b Main guide roller
1c Main guide roller
1d Main guide roller
2 Wire delivering bobbin
3 Wires
CL Cutting wire sections
PS Parallel wire sections
4 Wire winding bobbin
5 Work piece
6a, 6b Power feed terminal units
7a, 7b Damping guide rollers
8 (8a, 8b) Nozzles
9 Wafer-parallel-direction moving stage
10 Lifting and lowering stage
11 Machining power supply unit
12 Wafer supporting sections
13 Thin line bundle sections
14 Insertion supporting sections
15 Wafer supporting section stands
15a, 15b Cutting-time wafer supporting sections
16a, 16b Finishing-time wafer supporting sections
17 Rolling rollers
18a, 18b Wafer-supporting-section insertion control
15 plates
19a, 19b Columns
20 Base
21 Guide shafts
22 Springs
23 Track of cutting wire sections
K Power feed terminals
GR Cutting grooves

1. A wire discharge machining apparatus comprising:
a pair of guide rollers disposed in parallel at intervals;
a wire that is wound between the pair of guide rollers a plurality of times while being spaced apart from each other at a fixed pitch to form a parallel wire section between the pair of guide rollers and travels according to the rotation of the guide rollers;
a pair of damping guide rollers that are provided between the pair of guide rollers, follow and come into contact with the parallel wire section, and form a plurality of damped cutting wire sections;
a plurality of power feed terminals that feed electric power to each of the cutting wire sections; and
a unit that moves a work piece to the cutting wire sections relatively in a parallel direction of wires forming the cutting wire sections and a direction perpendicular to the parallel direction of the wires forming the cutting wire sections in such a manner as to bring the wires of the cutting wire sections closer to either one of a pair of cut surfaces formed by being cut by the wires of the cutting wire sections than the other, wherein
the wire discharge machining apparatus scans either one of the cut surfaces in a discharge-machined state to thereby simultaneously finish the cut surfaces.

2. The wire discharge machining apparatus according to claim 1, further comprising:
cutting-time wafer supporting sections that support the wafers during the cutting; and
finishing-time wafer supporting sections that support the wafers during the finishing, wherein
the cutting wire sections include a function of not completely separating a plurality of wafers cut out from the work piece by discharge machining of the cutting wire sections and, after completing the finishing to leave a connecting portion in a state in which a part of the wafers is integral with the work piece, cutting the connecting portion.

3. The wire discharge machining apparatus according to claim 2, wherein the finishing-time wafer supporting sections are configured to repeat scanning of wafer surfaces a plurality of times while performing the discharge machining by the cutting wire sections.

4. The wire discharge machining apparatus according to claim 2, further comprising wafer-supporting-section insertion control plates that control behavior for bringing the cutting-time wafer supporting sections and the finishing-time wafer supporting sections close to and away from the work piece, wherein
the cutting-time wafer supporting sections and the finishing-time wafer supporting sections are parallel to a stretching direction of the cutting wire sections, disposed on both sides of the work piece, and configured to move substantially in parallel to the stretching direction of the cutting wire sections.

5. The wire discharge machining apparatus according to claim 2, wherein
the cutting-time wafer supporting sections and the machining-time wafer supporting sections include inserting sections that are formed by cutting, and inserted into machined grooves, which are to be formed as inter-wafer regions, and retain wafer intervals, insertion supporting sections that support the inserting sections, and rolling rollers connected to the insertion supporting sections, wherein
an insertion amount of the inserting sections into the machined grooves formed in the work piece is controlled when the rolling rollers roll along the surface shape of the wafer-supporting-section insertion control plates.

6. The wire discharge machining apparatus according to claim 5, wherein
the inserting sections are thin line bundle sections formed by binding thin lines, and
the cutting-time wafer supporting sections and the finishing-time wafer supporting sections are arranged on both sides of the work piece, pressed against an outer surface of the work piece substantially in parallel from a stretching direction of the cutting wire sections, and configured to hold the wafers and prevent vibration of the wafers when the thin line bundle sections of the cutting-time wafer supporting sections and the finishing-time wafer supporting sections are inserted into the machined grooves formed in the work piece.

7. The wire discharge machining apparatus according to claim 4, wherein the surface shape of the wafer-supporting-section insertion control plates are similar to an external shape of the work piece.

8. The wire discharge machining apparatus according to claim 4, wherein the wafer-supporting-section insertion control plates move relatively to the cutting-time wafer supporting sections and the finishing-time wafer supporting sections in a direction perpendicular to a parallel direction of each of the wires forming the cutting wire sections.

9. A manufacturing method for semiconductor wafers using a wire discharge machining apparatus including:
a plurality of guide rollers disposed in parallel at intervals;
a wire that is wound between the plurality of guide rollers while being spaced apart from each other at a fixed pitch to form cutting wire sections between a pair of the guide rollers within the plurality of guide rollers and travels according to the rotation of the guide rollers;
power feed terminals that feed electric power to wires of the cutting wire sections; and
a unit that moves a work piece to the cutting wire sections in a parallel direction of wires forming each of the cutting wire sections and a direction perpendicular to the parallel direction of the wires forming the cutting wire sections in such a manner as to bring the wires of the cutting wire sections closer to either one of a pair of cut surfaces formed by being cut by the wires of the cutting wire sections than to the other, the manufacturing method comprising:
a first step of cutting a work piece with the cutting wire sections and cutting out a plurality of wafers from the work piece; and
a second step of bringing the wires of the cutting wire sections closer to either one of a pair of cut surfaces formed by being cut at the first step using the wires of the cutting wire sections than to the other and scanning the cut surfaces in a discharge-machined state.

10. The manufacturing method for semiconductor wafers according to claim 9, wherein
the first step includes a step of cutting the work piece with the cutting wire sections and suspending a cut-out of semiconductor wafers from the work piece in a state in which a part of the semiconductor wafers is connected to the work piece, wherein
in the second step, the cut surfaces cut at the first step are scanned in the discharge-machined state using the wires of the cutting wire sections.

11. The manufacturing method for semiconductor wafers according to claim 9, wherein the second step is performed a plurality of times.

12. The manufacturing method for semiconductor wafers according to claim 9, wherein, after the second step, a third step of arranging the wires in positions where the cut-out of the semiconductor wafers is suspended, reciprocatingly moving the wires in a thickness direction of gaps cut by the wires while performing discharge machining, and simultaneously advancing the suspended cut-out step is performed.

13. The manufacturing method for semiconductor wafers according to claim 9, wherein, after the second step, a fourth step of arranging the wires in positions where cut-out of the semiconductor wafers is suspended, performing cutting by discharge machining in a direction orthogonal to a traveling direction in the wire cutting process to cut off the semiconductor wafers from the work piece, and forming the cut-off portions as orientation flat surfaces is performed.

14. The manufacturing method for semiconductor wafers according to claim 9, wherein the work piece is a semiconductor ingot containing at least one of carbide or nitride as a component.

15. The wire discharge machining apparatus according to claim 5, wherein the surface shape of the wafer-supporting-section insertion control plates are similar to an external shape of the work piece.

16. The wire discharge machining apparatus according to claim 5, wherein the wafer-supporting-section insertion control plates move relatively to the cutting-time wafer supporting sections and the finishing-time wafer supporting sections in a direction perpendicular to a parallel direction of each of the wires forming the cutting wire sections.
